(19) United States
(12) Patent Application Publication
(10) Pub. No.: US 2026/0089823 A1
(43) Pub. Date: Mar. 26, 2026

(54) TECHNIQUES FOR PROVIDING OUTPUTS

(71) Applicant: Apple, Inc., Cupertino, CA (US)

(72) Inventors: Brian T. GLEESON, Mountain View, CA (US); Steven J. TAYLOR, Los Gatos, CA (US); Thomas S. HULBERT, Sunnyvale, CA (US); Arian BEHZADI, San Francisco, CA (US); Megan M. SAPP, Napa, CA (US); Peter RIERING-CZEKALLA, Oakland, CA (US)

(21) Appl. No.: 19/300,368

(22) Filed: Aug. 14, 2025

Related U.S. Application Data
(60) Provisional application No. 63/698,991, filed on Sep. 25, 2024.

(51) Int. Cl. H05B 47/19; F21S 10/02; F21V 23/04; F21V 33/00; F21Y 113/10; H05B 47/115

(52) U.S. Cl. CPC H05B 47/19; F21S 10/023; F21V 23/0471; F21V 23/0492; F21V 33/0052; H05B 47/115; F21Y 2113/10

(57) ABSTRACT

The present disclosure generally relates to providing outputs. Some techniques are for providing an output in accordance with some embodiments. Other techniques are for outputting illumination in accordance with some embodiments.

### CROSS-REFERENCE TO RELATED APPLICATIONS

The present patent application claims priority to U.S. Provisional Patent Application Ser. No. 63/698,991, entitled “TECHNIQUES FOR PROVIDING OUTPUTS” filed Sep. 25, 2024, which is hereby incorporated by reference in its entirety for all purposes.

### FIELD

The present disclosure relates generally to computer user interfaces, and more specifically to techniques for providing outputs.

### BACKGROUND

Electronic devices often output notifications to alert a user to the occurrence of an event. Such notifications can indicate what type of event has occurred.

### SUMMARY

Some techniques for providing outputs using electronic devices are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient processes and interfaces for providing outputs. Such processes and interfaces optionally complement or replace other processes for providing outputs. Such processes and interfaces reduce the cognitive burden on a user and produce a more efficient human-machine interface. For battery-operated computing devices, such processes and interfaces conserve power and increase the time between battery charges.

In some embodiments, a method that is performed at a device stand that includes one or more input devices and one or more output devices is described. In some embodiments, the method comprises: detecting, via the one or more input devices of the device stand, a voice input, wherein the device stand includes an attachment point that is configured to attach to an external device and hold the external device in a respective pose relative to a physical environment; and in response to detecting the voice input, outputting, via the one or more output devices of the device stand, a respective output that is generated based on the voice input.

In some embodiments, a non-transitory computer-readable storage medium storing one or more programs configured to be executed by one or more processors of a device stand that includes one or more input devices and one or more output devices is described. In some embodiments, the one or more programs includes instructions for: detecting, via the one or more input devices of the device stand, a voice input, wherein the device stand includes an attachment point that is configured to attach to an external device and hold the external device in a respective pose relative to a physical environment; and in response to detecting the voice input, outputting, via the one or more output devices of the device stand, a respective output that is generated based on the voice input.

In some embodiments, a transitory computer-readable storage medium storing one or more programs configured to be executed by one or more processors of a device stand that includes one or more input devices and one or more output devices is described. In some embodiments, the one or more programs includes instructions for: detecting, via the one or more input devices of the device stand, a voice input, wherein the device stand includes an attachment point that is configured to attach to an external device and hold the external device in a respective pose relative to a physical environment; and in response to detecting the voice input, outputting, via the one or more output devices of the device stand, a respective output that is generated based on the voice input.

In some embodiments, a device stand that includes one or more input devices and one or more output devices is described. In some embodiments, the device stand that includes one or more input devices and one or more output devices comprises one or more processors and memory storing one or more programs configured to be executed by the one or more processors. In some embodiments, the one or more programs includes instructions for: detecting, via the one or more input devices of the device stand, a voice input, wherein the device stand includes an attachment point that is configured to attach to an external device and hold the external device in a respective pose relative to a physical environment; and in response to detecting the voice input, outputting, via the one or more output devices of the device stand, a respective output that is generated based on the voice input.

In some embodiments, a device stand that includes one or more input devices and one or more output devices is described. In some embodiments, the device stand that includes one or more input devices and one or more output devices comprises means for performing each of the following steps: detecting, via the one or more input devices of the device stand, a voice input, wherein the device stand includes an attachment point that is configured to attach to an external device and hold the external device in a respective pose relative to a physical environment; and in response to detecting the voice input, outputting, via the one or more output devices of the device stand, a respective output that is generated based on the voice input.

In some embodiments, a computer program product is described. In some embodiments, the computer program product comprises one or more programs configured to be executed by one or more processors of a device stand that includes one or more input devices and one or more output devices. In some embodiments, the one or more programs include instructions for: detecting, via the one or more input devices of the device stand, a voice input, wherein the device stand includes an attachment point that is configured to attach to an external device and hold the external device in a respective pose relative to a physical environment; and in response to detecting the voice input, outputting, via the one or more output devices of the device stand, a respective output that is generated based on the voice input.

In some embodiments, a method that is performed at a device stand that includes one or more light sources is described. In some embodiments, the method comprises: while an external device is coupled to the device stand, wherein the device stand includes an attachment point that is configured to attach to the external device and hold the external device in a respective pose relative to a physical environment, detecting a respective event corresponding to the external device; and in response to detecting the respective event corresponding to the external device and in accordance with a determination that the respective event is a first event, illuminating, via the one or more light sources, a first portion of the device stand in a first manner.

In some embodiments, a non-transitory computer-readable storage medium storing one or more programs configured to be executed by one or more processors of a device stand that includes one or more light sources is described. In some embodiments, the one or more programs includes instructions for: while an external device is coupled to the device stand, wherein the device stand includes an attachment point that is configured to attach to the external device and hold the external device in a respective pose relative to a physical environment, detecting a respective event corresponding to the external device; and in response to detecting the respective event corresponding to the external device and in accordance with a determination that the respective event is a first event, illuminating, via the one or more light sources, a first portion of the device stand in a first manner.

In some embodiments, a transitory computer-readable storage medium storing one or more programs configured to be executed by one or more processors of a device stand that includes one or more light sources is described. In some embodiments, the one or more programs includes instructions for: while an external device is coupled to the device stand, wherein the device stand includes an attachment point that is configured to attach to the external device and hold the external device in a respective pose relative to a physical environment, detecting a respective event corresponding to the external device; and in response to detecting the respective event corresponding to the external device and in accordance with a determination that the respective event is a first event, illuminating, via the one or more light sources, a first portion of the device stand in a first manner.

In some embodiments, a device stand that includes one or more light sources is described. In some embodiments, the device stand that includes one or more light sources comprises one or more processors and memory storing one or more programs configured to be executed by the one or more processors. In some embodiments, the one or more programs includes instructions for: while an external device is coupled to the device stand, wherein the device stand includes an attachment point that is configured to attach to the external device and hold the external device in a respective pose relative to a physical environment, detecting a respective event corresponding to the external device; and in response to detecting the respective event corresponding to the external device and in accordance with a determination that the respective event is a first event, illuminating, via the one or more light sources, a first portion of the device stand in a first manner.

In some embodiments, a device stand that includes one or more light sources is described. In some embodiments, the device stand that includes one or more light sources comprises means for performing each of the following steps: while an external device is coupled to the device stand, wherein the device stand includes an attachment point that is configured to attach to the external device and hold the external device in a respective pose relative to a physical environment, detecting a respective event corresponding to the external device; and in response to detecting the respective event corresponding to the external device and in accordance with a determination that the respective event is a first event, illuminating, via the one or more light sources, a first portion of the device stand in a first manner.

In some embodiments, a computer program product is described. In some embodiments, the computer program product comprises one or more programs configured to be executed by one or more processors of a device stand that includes one or more light sources. In some embodiments, the one or more programs include instructions for: while an external device is coupled to the device stand, wherein the device stand includes an attachment point that is configured to attach to the external device and hold the external device in a respective pose relative to a physical environment, detecting a respective event corresponding to the external device; and in response to detecting the respective event corresponding to the external device and in accordance with a determination that the respective event is a first event, illuminating, via the one or more light sources, a first portion of the device stand in a first manner.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for providing outputs, thereby increasing the effectiveness, efficiency, and user satisfaction with such devices. Such processes and interfaces may complement or replace other processes for providing outputs.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AE illustrate exemplary user interfaces for providing outputs in accordance with some embodiments.

FIG. 7 is a flow diagram illustrating a process for providing an output in accordance with some embodiments.

FIG. 8 is a flow diagram illustrating a process for outputting illumination in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for providing outputs. For example, a device stand can output various types of illumination in response to detecting a voice input. As another example, the device stand can output illumination based on an external device receiving and/or generating a notification. Such techniques can reduce the cognitive burden on a user who operates the device stand, thereby enhancing productivity. Further, such techniques can reduce processor and battery power otherwise wasted on redundant user inputs.

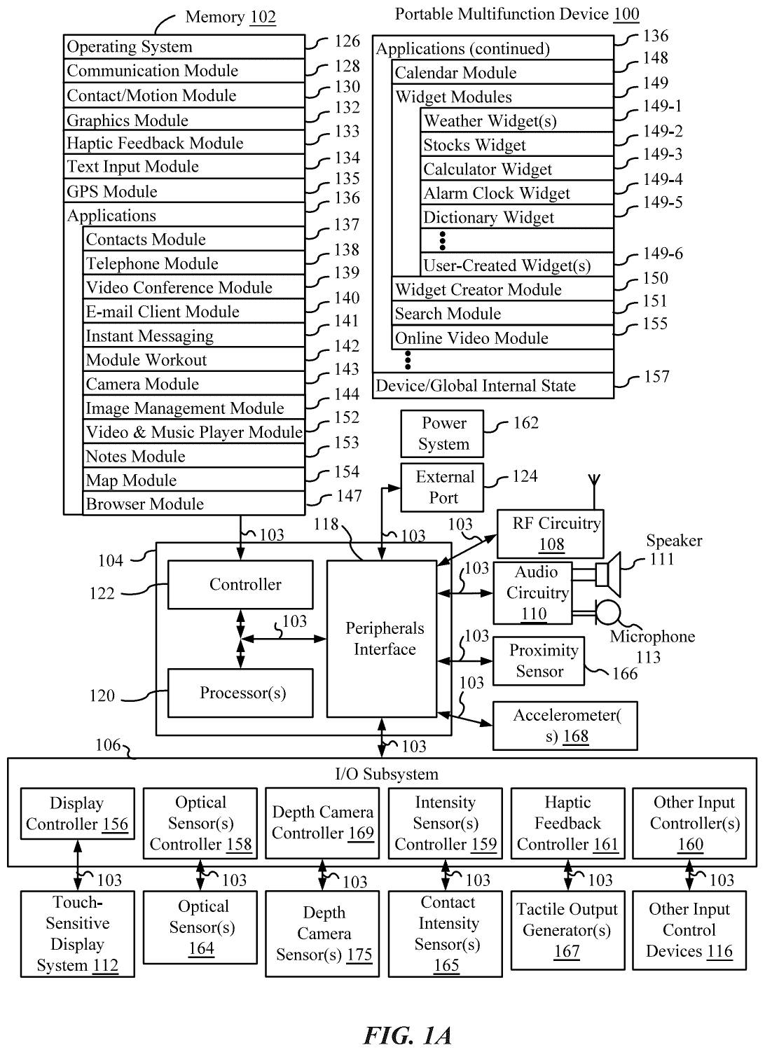

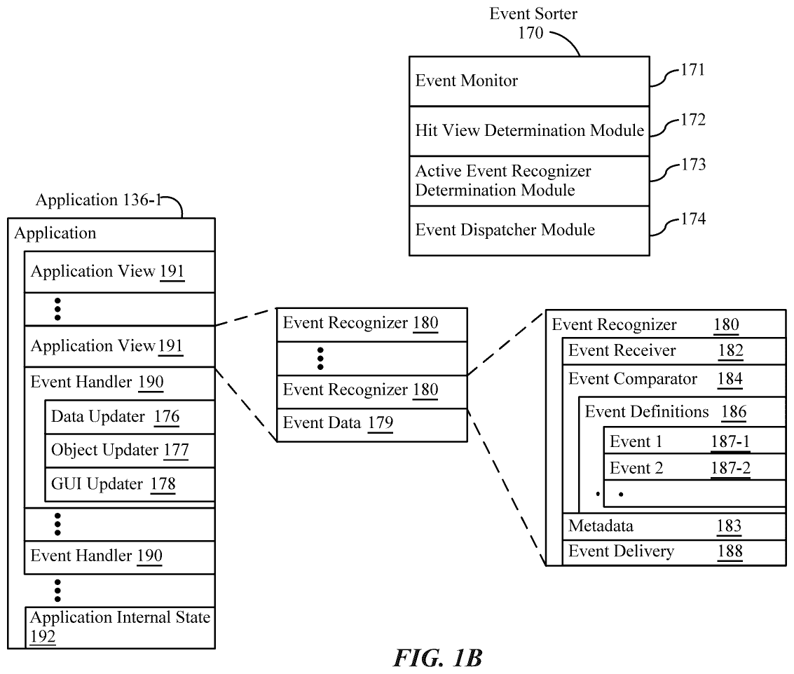

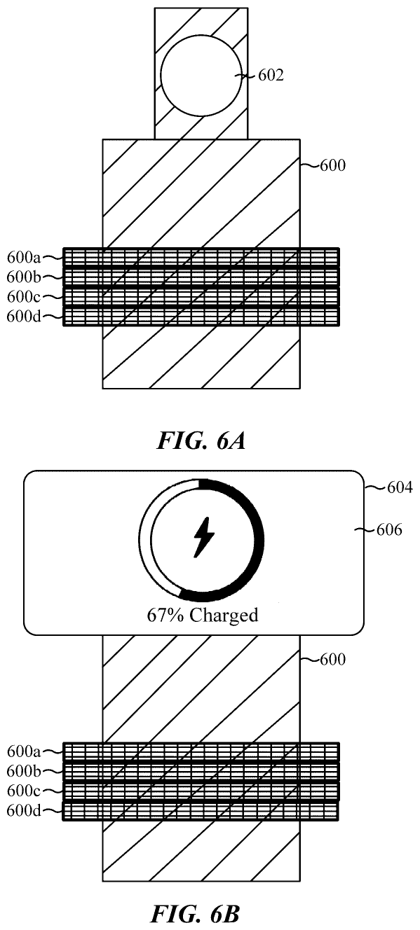

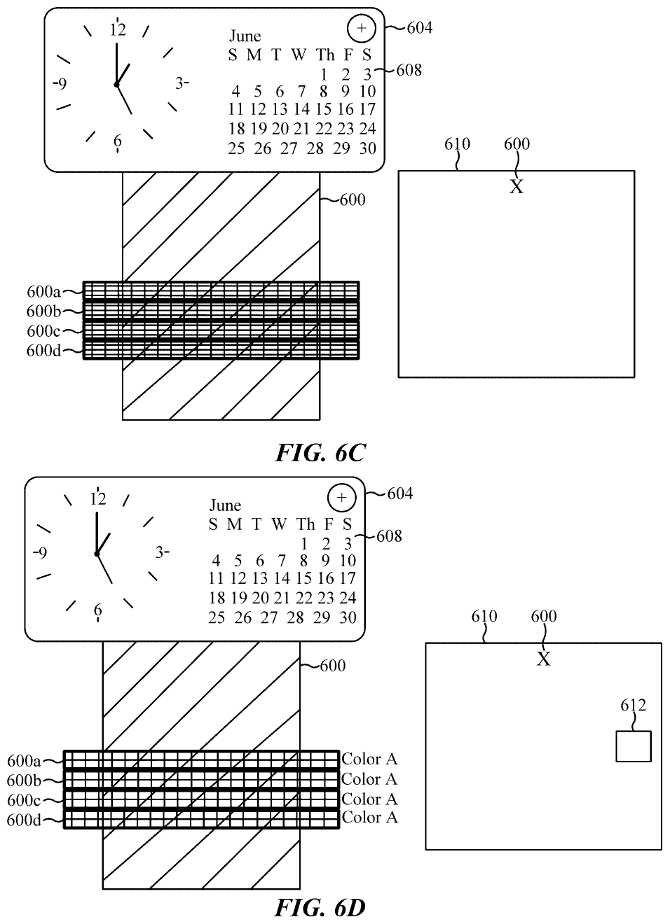

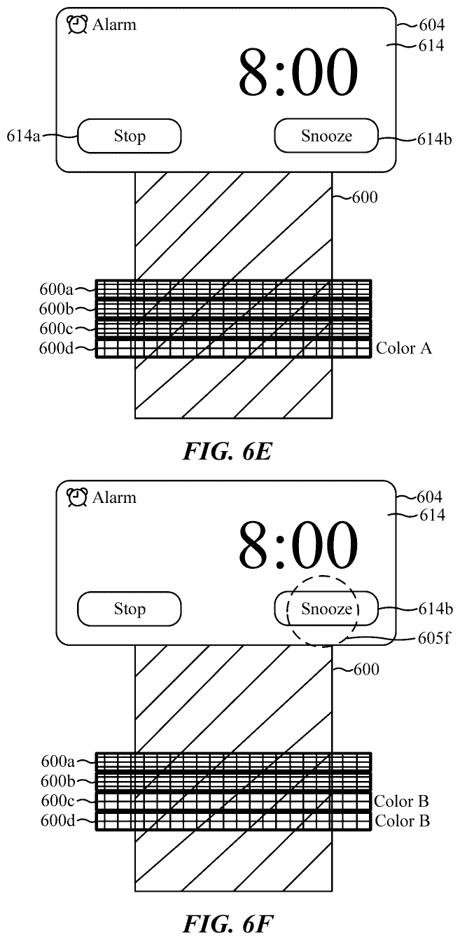

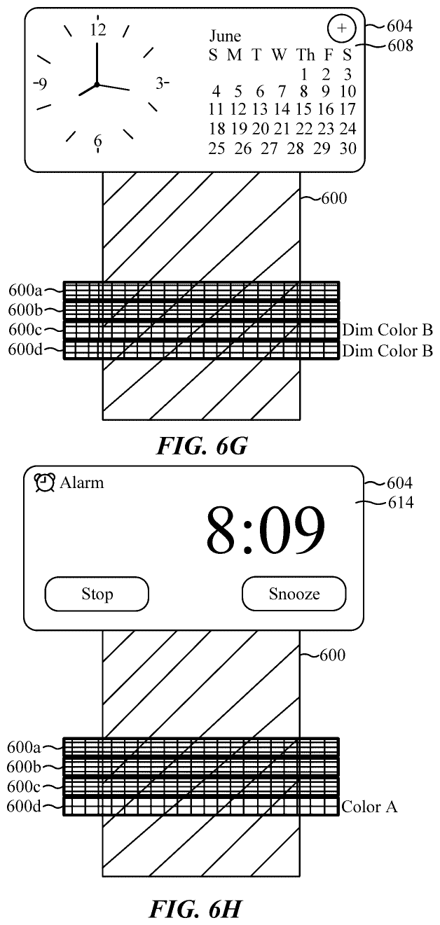

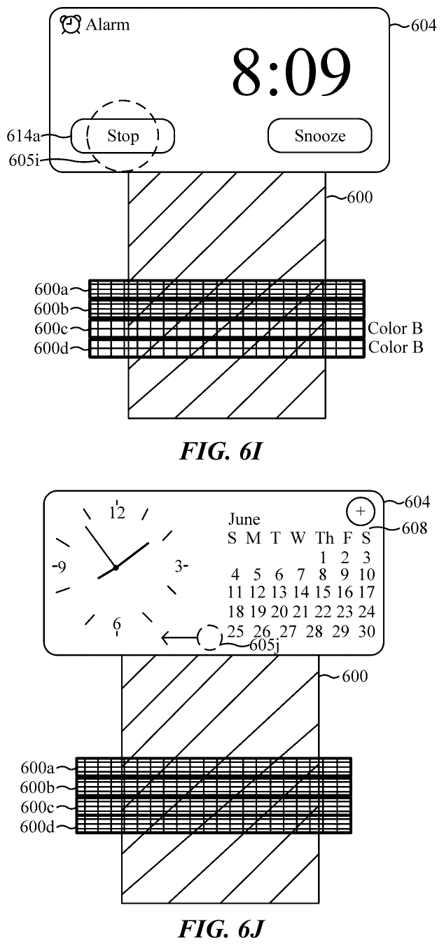

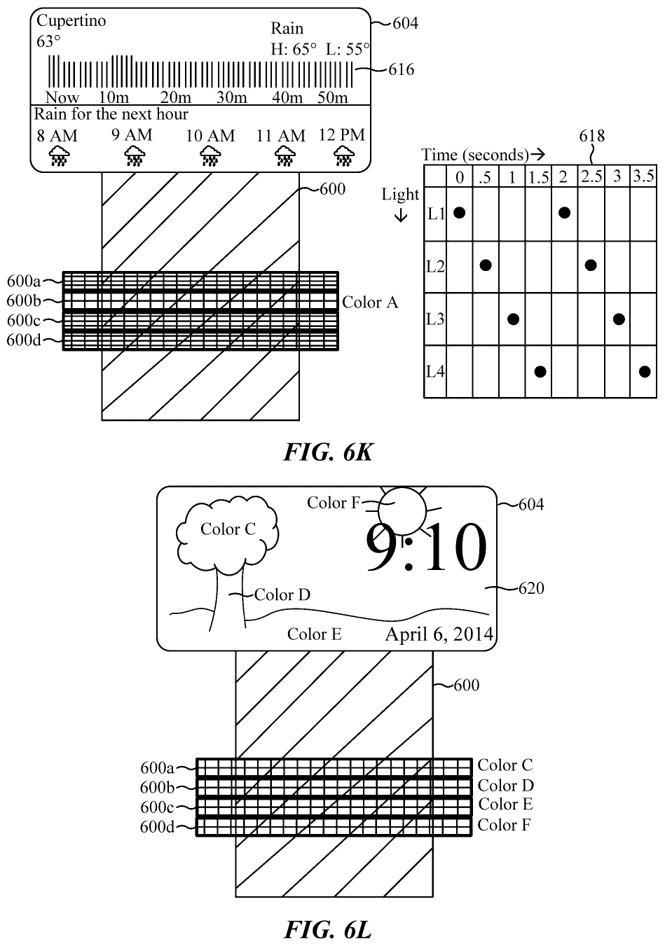

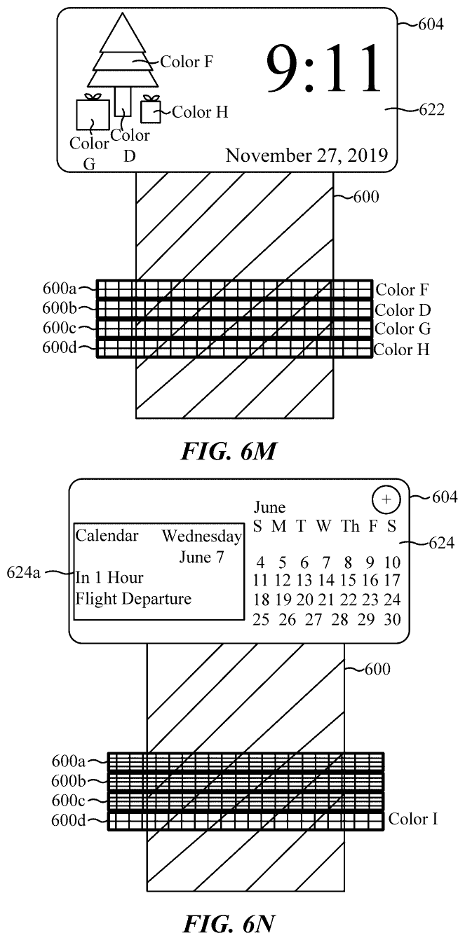

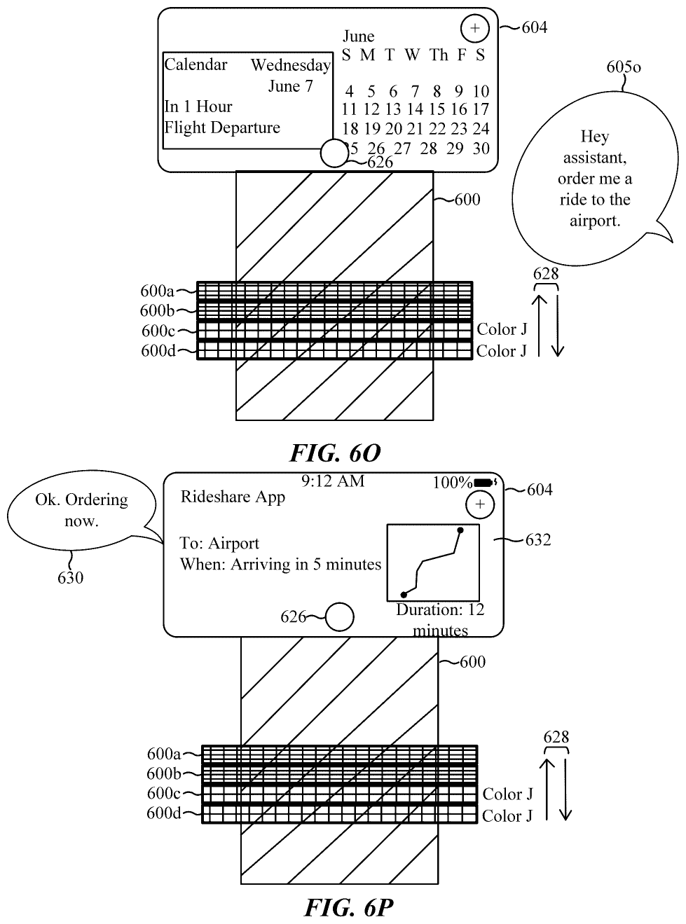

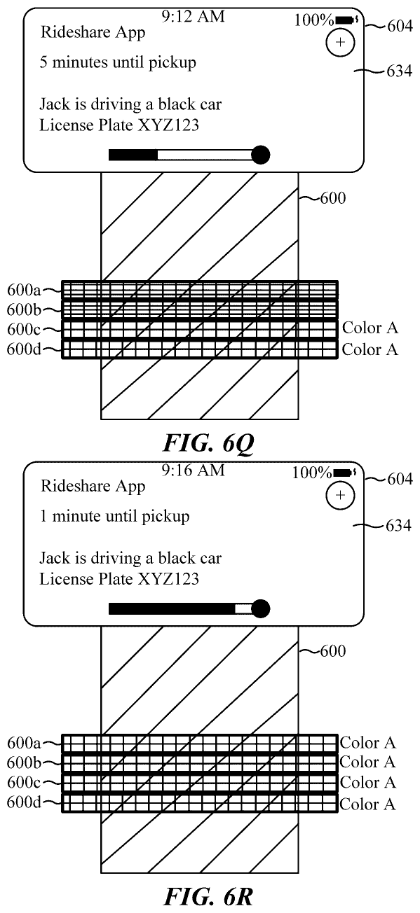

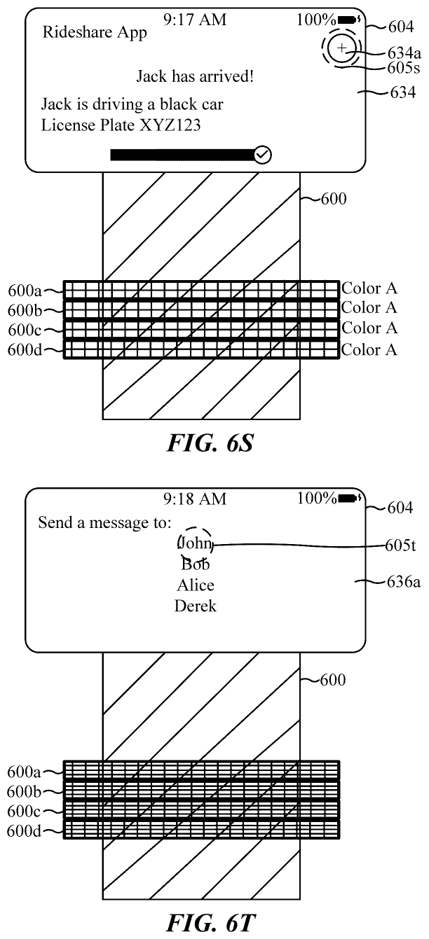

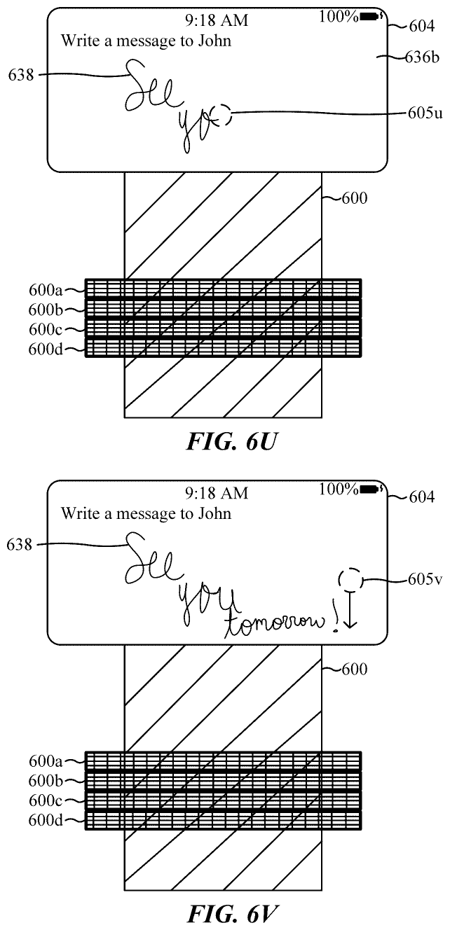

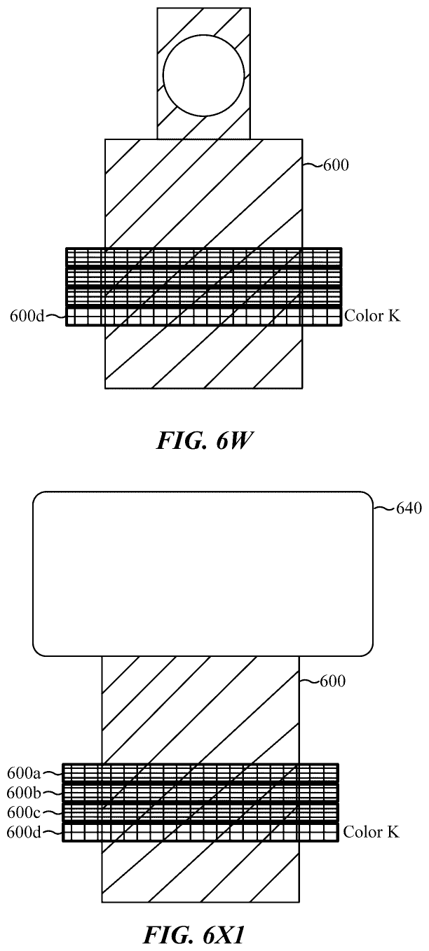

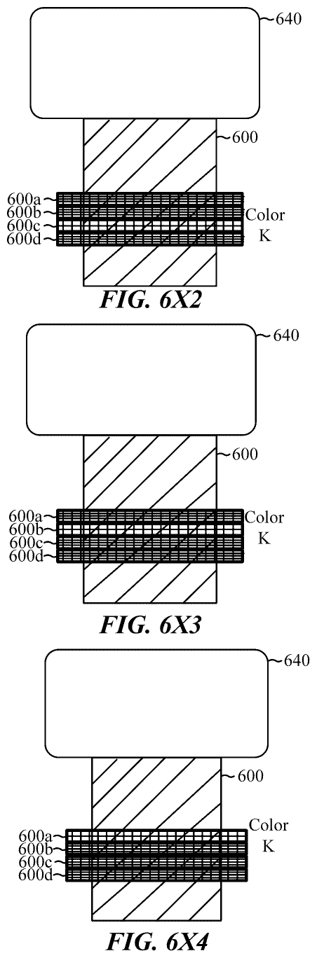

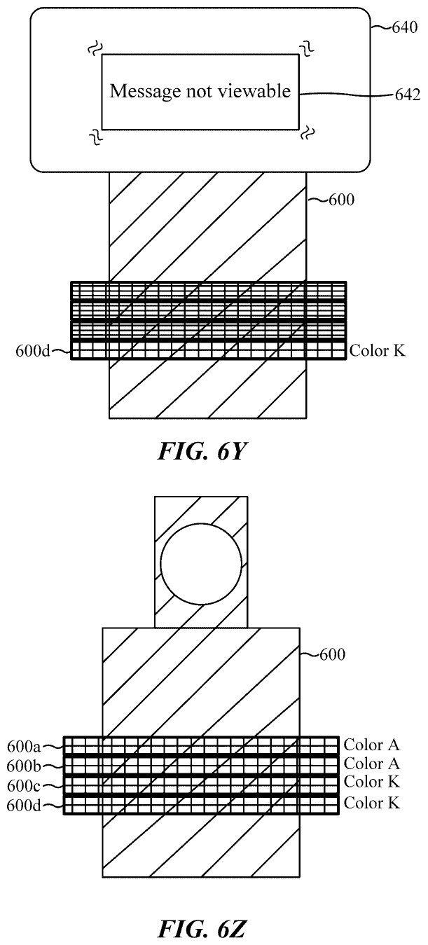

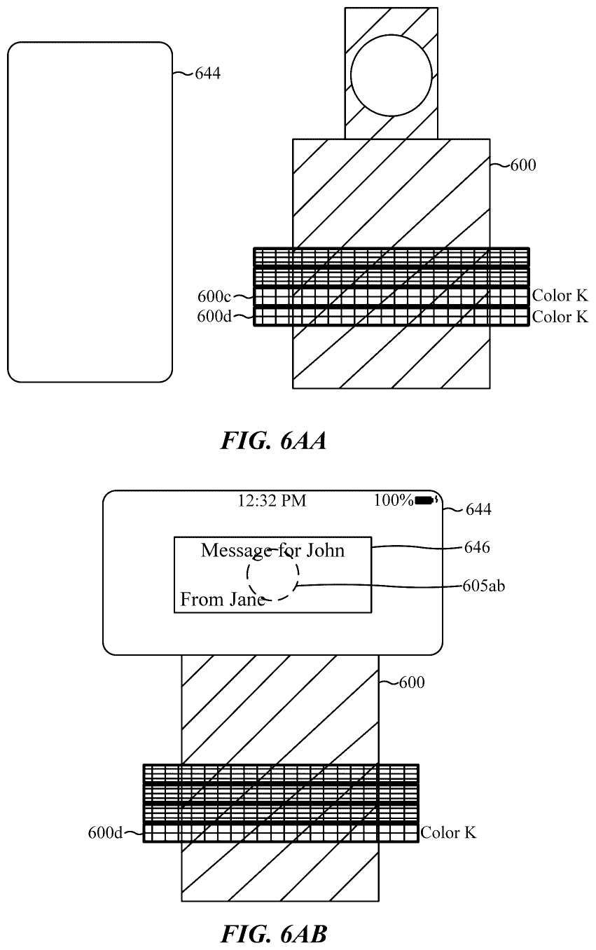

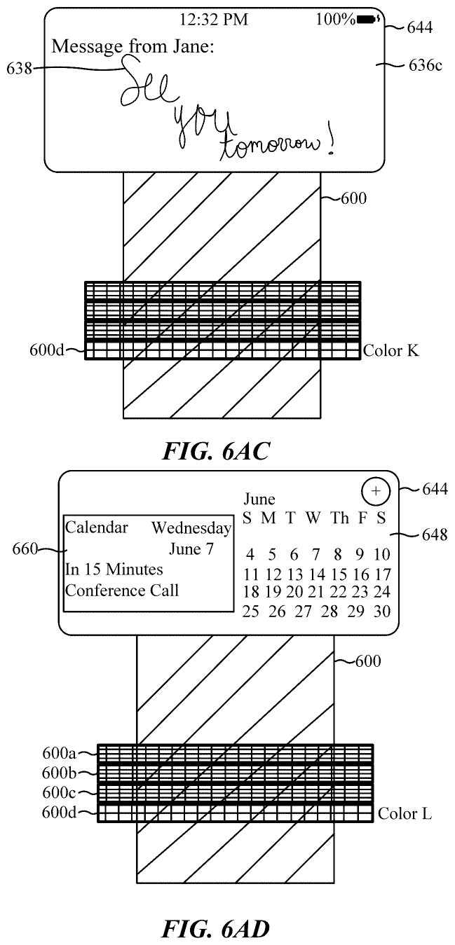

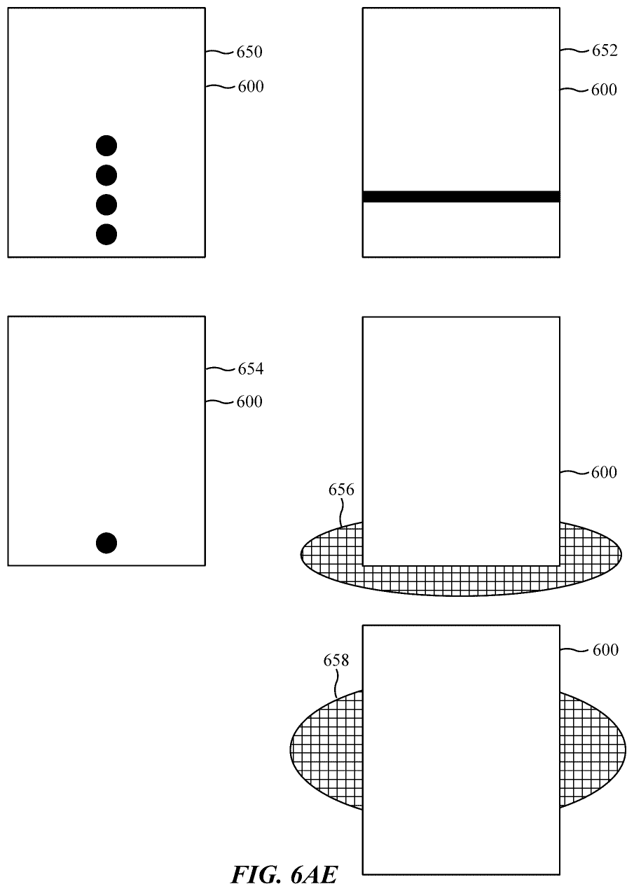

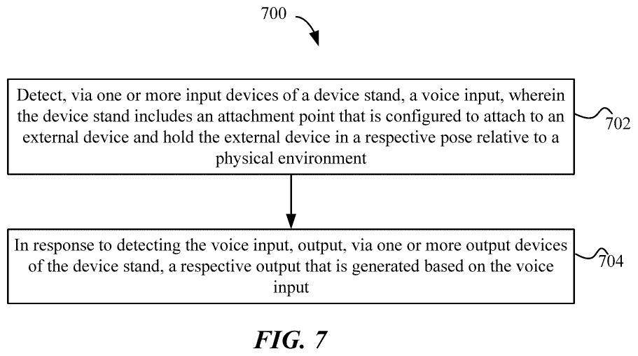

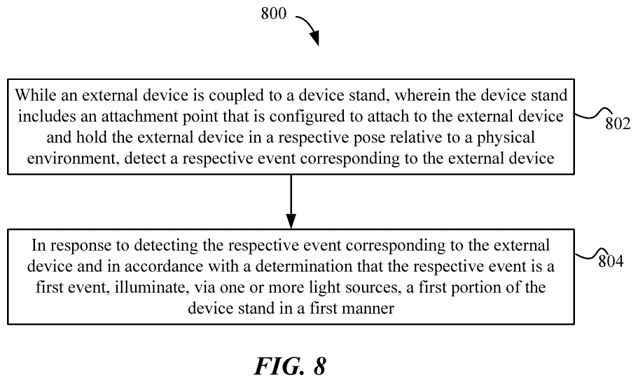

Below, FIGS. 1A-1B, 2, 3A-3G, 4A-4B, and 5A-5B provide a description of exemplary devices for performing the techniques for providing outputs. FIGS. 6A-6AE illustrate exemplary user interfaces for providing outputs in accordance with some embodiments. FIG. 7 is a flow diagram illustrating a process for providing an output in accordance with some embodiments. FIG. 8 is a flow diagram illustrating a process for outputting illumination in accordance with some embodiments. The user interfaces in FIGS. 6A-6AE are used to illustrate the processes described below, including the processes in FIGS. 7 and 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

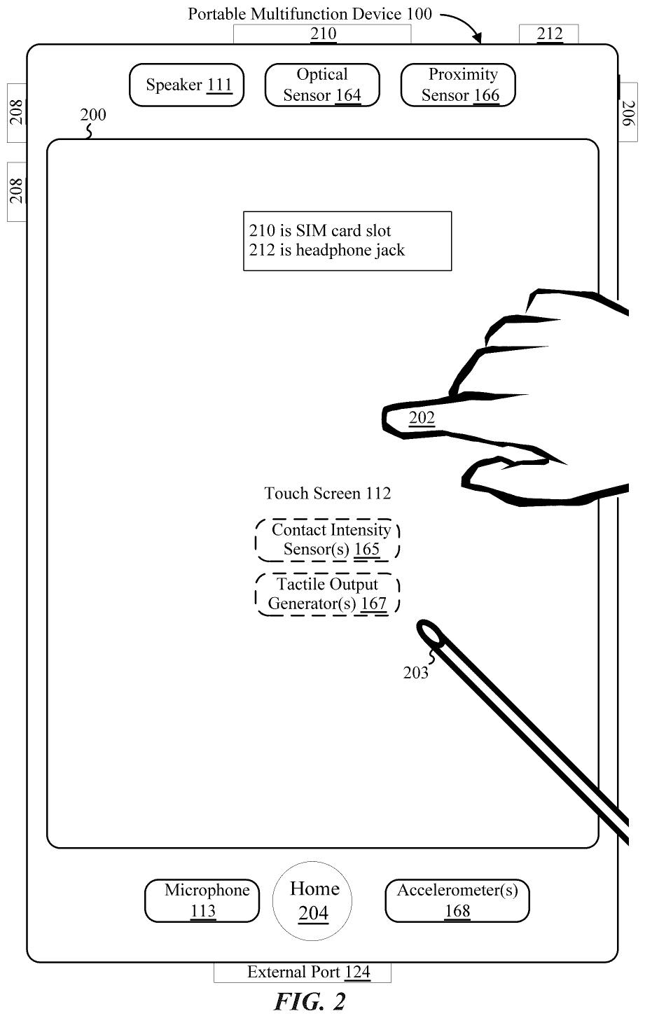

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

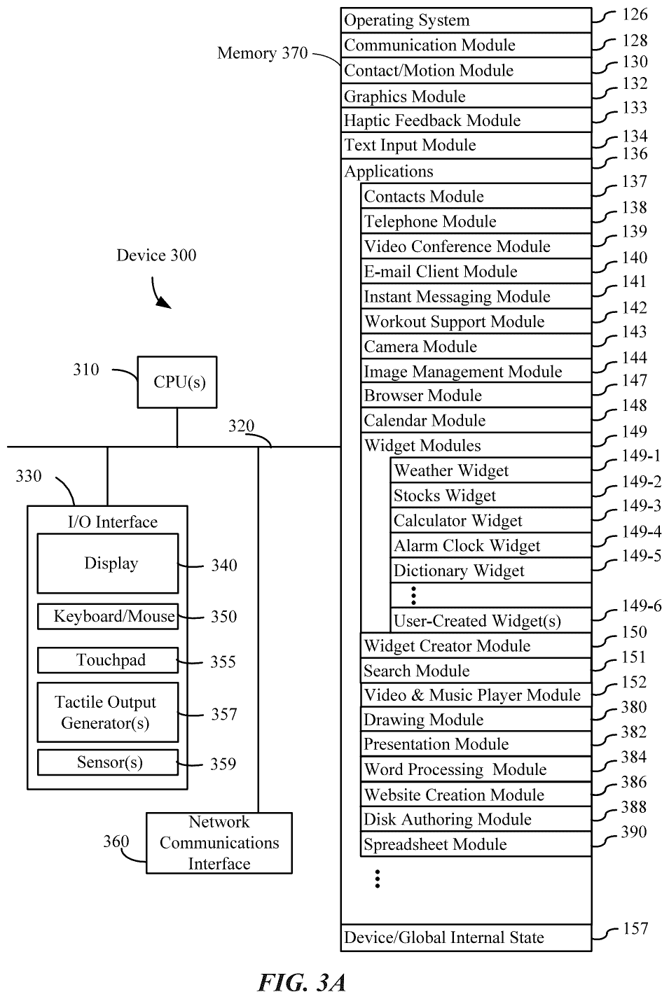

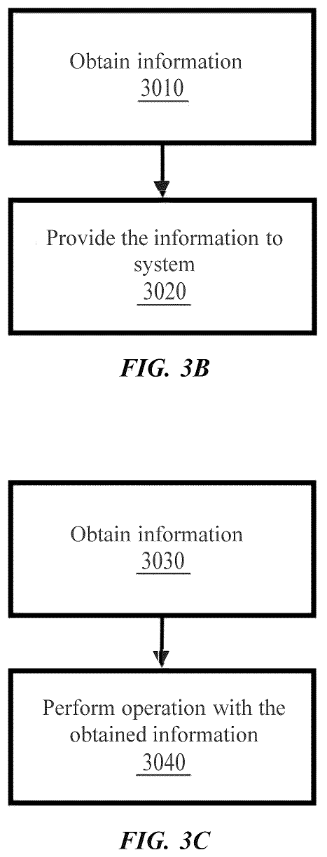

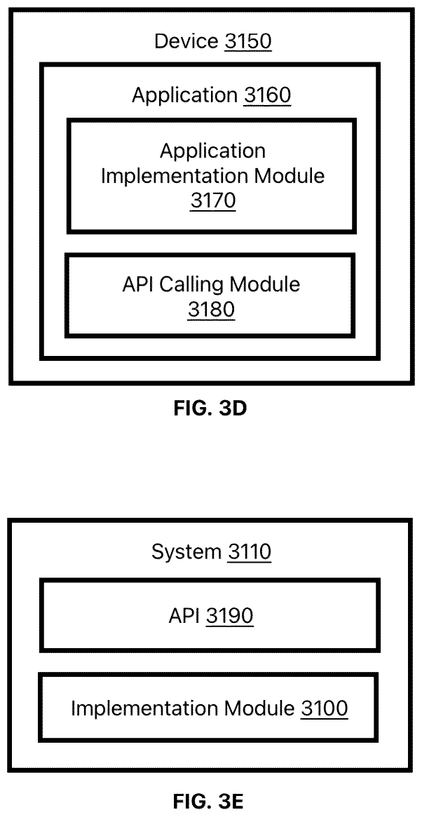

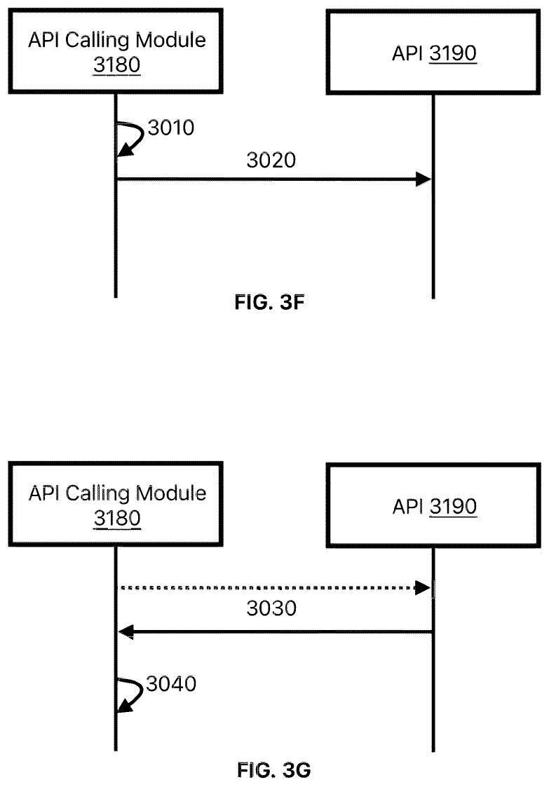

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the process of FIG. 3B, the process of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second party application). In some embodiments, application 3160 is an application that is provided via an application store. In some embodiments, the application store can be an application store that is pre-installed on device 3150 at purchase (e.g., a first party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the process of FIG. 3B and/or the process of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the process of FIG. 3B and/or the process of FIG. 3C by calling an application programming interface (API) (e.g., API 3190) provided by system 3110. In some embodiments, application 3160 performs at least a portion of the process of FIG. 3B and/or the process of FIG. 3C without calling API 3190.

In some embodiments, one or more steps of the process of FIG. 3B and/or the process of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection, such as with an accessory), a device detection API (e.g., for locating nearby devices, such as media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, and/or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then information is sent (e.g., via an API) to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is a third-party application (e.g., an application that is provided by an application store, downloaded via a network, and/or read from a storage device). In some embodiments, the application controls the first computer system to perform processes 700 and 800 (FIGS. 7 and 8) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the different module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

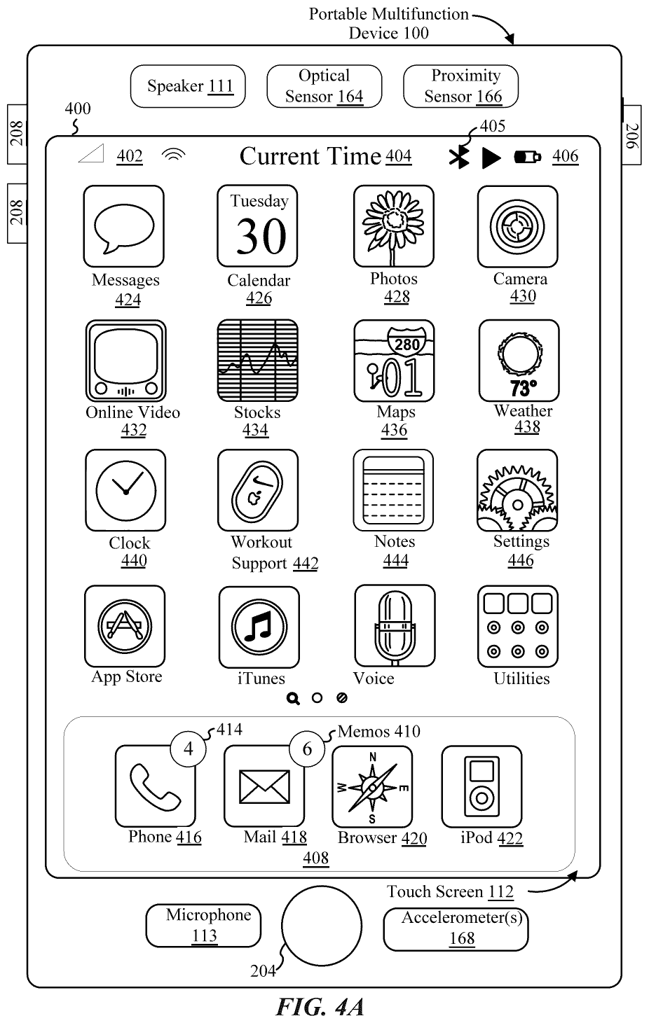

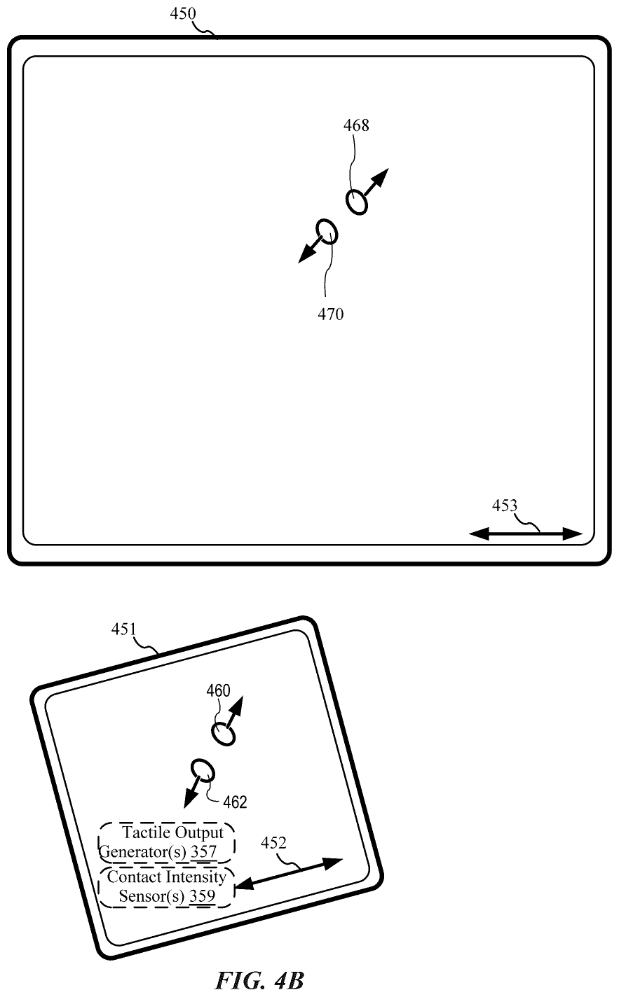

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

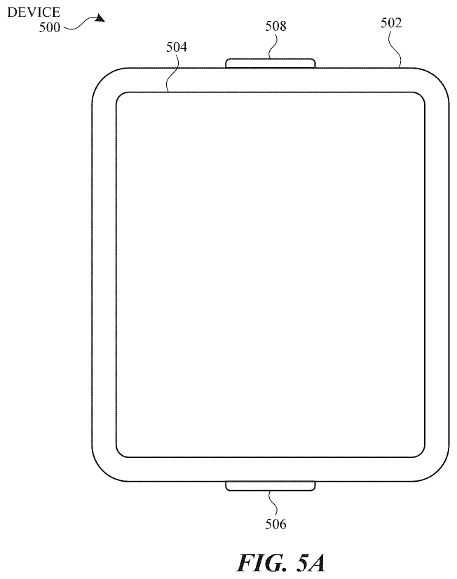

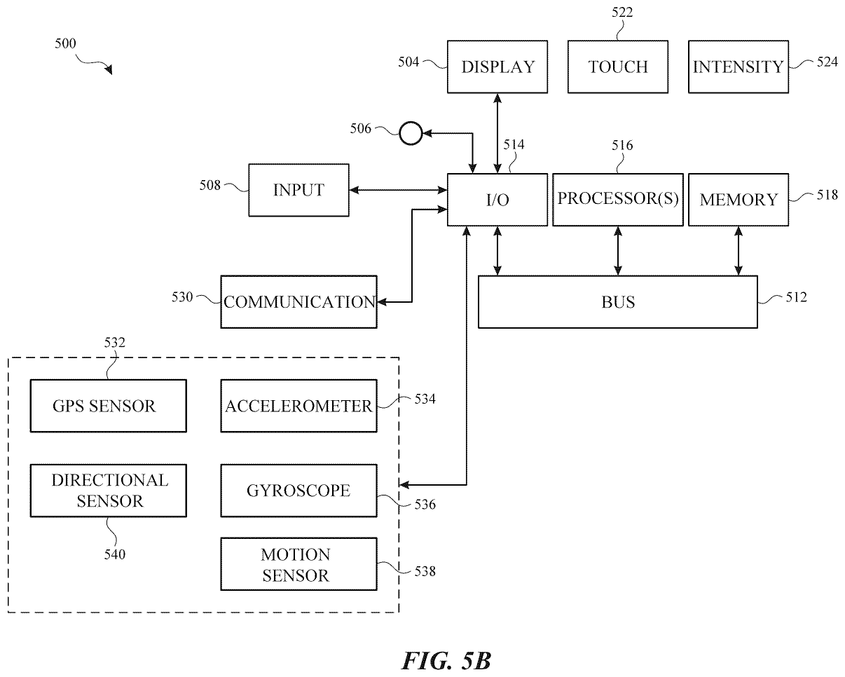

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A-3G. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700 and 800 (FIGS. 7 and 8). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A-3G, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

Attention is now directed towards embodiments of user interfaces (“UI”) and associated processes that are implemented on an electronic device, such as portable multifunction device 100, device 300, or device 500.

FIGS. 6A-6AE illustrate exemplary user interfaces for providing an output in accordance with some embodiments. The user interfaces in these figures are used to illustrate the processes described below, including the processes in FIGS. 7 and 8.

FIGS. 6A-6AE illustrate processes for a device stand to output different illuminations based on detection of different interactions, including voice inputs, touch inputs, notifications, live activities, alarms, weather, displayed content by an external computer system, and/or presence of a subject (e.g., a user and/or a person) relative to an external computer system and/or to the device stand. In some embodiments, the device stand includes and/or is in communication with one or more input devices (e.g., a sensor, a camera, a lidar detector, a motion sensor, an infrared sensor, a touch-sensitive surface, and/or a microphone). Such input devices can be used to detect the presence of, attention of, statements from, inputs corresponding to, requests from, and/or instructions of a subject.

FIG. 6A illustrates device stand 600. Device stand 600 is a device which is configured to be coupled to an external computer system (e.g., a smartphone and/or tablet, such as computer system 604 as illustrated in FIG. 6B). In some embodiments, the external computer system is coupled to device stand 600 such that a subject can view the external computer system at an elevated level, view various notifications related to the external computer system and/or device stand 600, and/or to charge the external computer system. In some embodiments, the external computer system couples to device stand 600 via attachment point 602. In such embodiments, attachment point 602 can include magnets that are configured to magnetically couple the external computer system to device stand 600.

FIG. 6A depicts indicators 600a-d. Indicators 600a-d represent a state of illumination of various portions of device stand 600. That is, an appearance of indicators 600a-d indicate whether various portions of device stand 600 are illuminated. More specifically, indicator 600a represents illumination of a first portion of device stand 600, indicator 600b represents illumination of a second portion of device stand 600, indicator 600c represents illumination of a third portion of device stand 600, and indicator 600d represents illumination of a fourth portion of device stand 600. In some embodiments, the various portions of device stand 600 are illuminated via one or more light sources that are integrated within device stand 600. In some embodiments, the various portions of device stand 600 are illuminated via one or more light sources that are external to device stand 600. In some embodiments, a density of hatching of indicators 600a-d indicate an amount of light that is output. For example, an appearance of the hatching of indicators 600a-d at FIG. 6A indicate that none of the various portions of device stand 600 are illuminated.

At FIG. 6B, computer system 604 (e.g., a personal device of a subject) is coupled to device stand 600 via attachment point 602. At FIG. 6B, device stand 600 detects that computer system 604 is coupled to device stand 600. At FIG. 6B, in response to detecting that computer system 604 is coupled to device stand 600, device stand 600 begins to wirelessly charge computer system 604. In some embodiments, device stand 600 does not begin to charge computer system 604 in response to detecting that computer system 604 is coupled to device stand 600 when computer system 604 is fully charged. In some embodiments, device stand 600 does not begin to charge computer system 604 in response to detecting that computer system 604 is coupled to device stand 600 when the battery life of computer system 604 is above a threshold.

As illustrated in FIG. 6B, because computer system 604 is being charged, computer system 604 displays charging user interface 606. Charging user interface 606 includes an indication of the current battery life of computer system 604 (e.g., “67% charged”) and the charging progress of computer system 604 (e.g., a circle filled in 67%). At FIG. 6B, the appearance of indicators 600a-d indicate that none of the various portions of device stand 600 are currently illuminated.

At FIG. 6C, computer system 604 has been inactive for a period of time greater than a time threshold (e.g., 0-180 seconds). At FIG. 6C, because computer system 604 has been inactive for the period of time that is greater than the time threshold, computer system 604 enters into an inactive state. In some embodiments, the inactive state is a mode of computer system 604 in which computer system 604 reduces its power consumption. In some embodiments, computer system 604 exits the inactive state in response to computer system 604 and/or device stand 600 detecting an input. As illustrated in FIG. 6C, because computer system 604 is in the inactive state, computer system 604 displays inactive state user interface 608. At FIG. 6C, inactive state user interface 608 includes (1) an analog clock that indicates that the current time is 1:00 AM and (2) a calendar of the present month (e.g., June).

FIG. 6C includes schematic 610 of an environment where computer system 604 and device stand 600 are located. A location of device stand 600 within the environment is represented by the X positioned at the top of schematic 610. At FIG. 6C, schematic 610 does not include any indications of respective subjects in the environment. Accordingly, at FIG. 6C, no subjects are present within the environment where computer system 604 and device stand 600 are located.

At FIG. 6D, as indicated by schematic 610, subject 612 enters the environment. Subject 612 is represented by the square that is within schematic 610. At FIG. 6D, device stand 600 detects that subject 612 has entered the environment. At FIG. 6D, in response to device stand 600 detecting that subject 612 has entered the environment, device stand 600 illuminates the first portion (e.g., that corresponds to indicator 600a), the second portion (e.g., that corresponds to indicator 600b), the third portion (e.g., that corresponds to indicator 600c), and the fourth portion (e.g., that corresponds to indicator 600d) of device stand 600 with color A. Accordingly, at FIG. 6D, indicators 600a-d have an appearance that indicate that the various portions of device stand 600 are illuminated. More specifically, the hatching of indicators 600a-d is less dense at FIG. 6D than the hatching of indicators 600a-d at FIGS. 6A-6C when no portion of device stand 600 is illuminated. In some embodiments, computer system 604 detects that subject 612 has entered the environment, such as using media (e.g., visual and/or auditory media) of the environment and/or using a message received from a personal device of subject 612 being carried by subject 612.

Recall that the current time (e.g., as indicated by the clock of inactive state user interface 608) is 1:00 AM. At FIG. 6D, device stand 600 illuminates the various portions of device stand 600 such that device stand 600 can act as a light source as subject 612 navigates through the environment (e.g., which is presumably dark due to the current time). In some embodiments, the various portions of device stand 600 are illuminated in response to detecting subject 612 only during particular hours (e.g., 12:00 AM-6 AM) or during hours manually selected by a subject.

Seven hours elapses between FIGS. 6D and 6E. At FIG. 6E, computer system 604 outputs a morning alarm. As illustrated in FIG. 6E, computer system 604 displays alarm user interface 614 as part of outputting the morning alarm. Alarm user interface 614 includes a representation of the current time (e.g., 8:00 AM) as well as stop control 614a and snooze control 614b. At FIG. 6E, device stand 600 detects that computer system 604 is outputting the morning alarm, such as based on audio, visual content, and/or haptic feedback produced by computer system 604 and/or using a message received from computer system 604. Because device stand 600 detects that computer system 604 is outputting the morning alarm, device stand 600 illuminates the fourth portion of device stand 600 with “color A” as a technique to alert the subject to the output of the morning alarm by computer system 604. In some embodiments, device stand 600 and/or computer system 604 outputs an audible tone as part of outputting the morning alarm.

At FIG. 6F, computer system 604 continues to output the morning alarm. At FIG. 6F, device stand 600 detects that computer system 604 continues to output the morning alarm. At FIG. 6F, in response to device stand 600 detecting that computer system 604 continues to output the morning alarm, device stand 600 illuminates the third portion and the fourth portion of device stand 600 with color B (e.g., a different color than color A). That is, as computer system 604 continues to output the morning alarm, device stand 600 changes the manner in which various portions of device stand 600 are illuminated and/or which portions of device stand 600 are illuminated. For example, as device stand 600 continues to detect that computer system 604 outputs the morning alarm, device stand 600 changes color, increases a brightness, and/or increases an intensity of the illumination of device stand 600 and/or which portions of device stand 600 are illuminated. In some embodiments, device stand 600 changes the illumination of the various portions of device stand 600 based on a determination that computer system 604 has continuously output the morning alarm for a threshold amount of time (e.g., 2-30 seconds). At FIG. 6F, device stand 600 changes the illumination of various portions of device stand 600 as a technique to alert the subject to the continued output of the alarm. At FIG. 6F, computer system 604 detects tap input 605f directed to snooze control 614b. It should be recognized that tap input 605f is an example of a selection input of snooze control 614b and that other types of inputs can be used such as an air gesture and/or a voice request to snooze the morning alarm.

At FIG. 6G, in response to detecting tap input 605f, computer system 604 suspends the output of the morning alarm and displays inactive state user interface 608. At FIG. 6G, computer system 604 is in the inactive state for the next nine minutes while the output of the morning alarm is suspended.

At FIG. 6G, device stand 600 detects that computer system 604 has suspended the output of the alarm. At FIG. 6G, in response to device stand 600 detecting that computer system 604 has suspended the output of the morning alarm, device stand 600 dims the illumination of the third portion and the fourth portion of device stand 600. In some embodiments, the dimming of the illumination of the third portion and the fourth portion of device stand 600 indicates that, even though computer system 604 is not actively outputting any indications of the morning alarm, the morning alarm remains active. It should be recognized that device stand 600 can change the illumination to other colors and/or change other portions, such as changing the illumination to color A and/or no longer illuminating the third portion as described above.

At FIG. 6H, a determination is made that a predetermined period of time (e.g., the amount of time that the morning alarm was snoozed) has elapsed since computer system 604 suspended the output of the morning alarm. At FIG. 6H, because the determination is made that the predetermined period of time has elapsed since computer system 604 suspended the output of the morning alarm, computer system 604 resumes outputting the morning alarm and displays alarm user interface 614 that indicates that the current time is 8:09. At FIG. 6H, device stand 600 detects that computer system 604 resumes outputting the morning alarm. Because device stand 600 detects that computer system 604 resumes outputting the morning alarm, device stand 600 illuminates the fourth portion of device stand 600 with color A (e.g., the same color of the illumination of the fourth portion of device stand 600 at FIG. 6E when computer system 604 began to output the morning alarm).

At FIG. 6I, device stand 600 detects that computer system 604 continues to output the morning alarm. In response to detecting that computer system 604 continues to output the alarm, device stand 600 illuminates the third portion and the fourth portion of device stand 600 with color B (e.g., a different color than color A). Device stand 600 changes the illumination of the third and the fourth portion of device stand 600 with color B as a technique to alert the subject that computer system 604 is continuing to output the morning alarm. At FIG. 6I, computer system 604 detects tap input 605i directed to stop control 614a. It should be recognized that tap input 605i is an example of a selection input of stop control 614a and that other types of inputs can be used such as an air gesture and/or a voice request to stop the morning alarm.

At FIG. 6J, in response to detecting tap input 605i, computer system 604 ceases to output the morning alarm and displays inactive state user interface 608. At FIG. 6J, device stand 600 detects that computer system 604 has ceased to output the morning alarm. At FIG. 6J, in response to detecting that computer system 604 has ceased to output the morning alarm, device stand 600 ceases to illuminate the third portion and the fourth portion of device stand 600 (e.g., as indicated by the appearance of indicator 600c and indicator 600d). That is, device stand 600 dims the illumination of various portions of device stand 600 when device stand 600 detects that computer system 604 suspends the output of the morning alarm and device stand 600 ceases to illuminate various portions of device stand 600 when device stand 600 detects that computer system 604 ceases to output the alarm. Put a different way, device stand 600 changes the illumination of device stand 600 differently based on the operation that computer system 604 performs. At FIG. 6J, computer system 604 detects leftward swipe input 605j directed to inactive state user interface 608. It should be recognized that leftward swipe input 605j is an example of a movement input and that other types of inputs can be used such as an air gesture and/or a voice request to no longer display inactive state user interface 608.

As illustrated in FIG. 6K, in response to detecting leftward swipe input 605j, computer system 604 displays weather user interface 616. Weather user interface 616 includes the current and future weather patterns for the location of computer system 604 (e.g., Cupertino, California), as well as the current, high, and low temperatures for the current day. At FIG. 6K, as indicated by weather user interface 616, the current weather for the location of computer system 604 is rain.

At FIG. 6K, while computer system 604 displays weather user interface 616, device stand 600 illuminates various portions of device stand 600 in such a way that mimics the current weather conditions indicated by weather user interface 616. For example, at FIG. 6K, because weather user interface 616 indicates that it is currently raining at the location of computer system 604, device stand 600 illuminates various portions of device stand 600 to mimic rain drops. More specifically, at FIG. 6K, device stand 600 illuminates various portions of device stand 600 in a downwardly descending manner. The downwardly descending manner in which device stand 600 illuminates the portions of device stand 600 mimics the pattern of rainfall.

The progression at which device stand 600 illuminates the various portions of device stand 600 to mimic the pattern of rainfall is illustrated by graphical representation 618. Graphical representation 618 indicates which portion of device stand 600 is being illuminated at various times. Each dot included in graphical representation 618 is representative of a portion of device stand 600 being illuminated at a particular time. For example, when computer system 604 initially displays weather user interface 616 (e.g., at 0 seconds), device stand 600 illuminates the first portion of device stand 600 (e.g., the portion of device stand 600 that corresponds to indicator 600a) (e.g., L1 in graphical representation 618). Half of a second after device stand 600 illuminates the first portion of device stand 600, device stand 600 illuminates the second portion of device stand 600 (e.g., the portion of device stand 600 that corresponds to indicator 600b) (e.g., L2 in graphical representation 618) that is located beneath the first portion. Half of a second after device stand 600 illuminates the second portion of device stand 600, device stand 600 illuminates the third portion of device stand 600 (e.g., that portion of device stand 600 that corresponds to indicator 600c) (e.g., L3 in graphical representation 618) that is positioned beneath the first portion and the second portion of device stand 600. Half of a second after device stand 600 illuminates the third portion of device stand 600, device stand 600 illuminates the fourth portion of device stand 600 (e.g., the portion of device stand 600 that corresponds to indicator 600d) (e.g., L4 in graphical representation 618) that is positioned beneath the first portion, the second portion, and the third portion of device stand 600.

In some embodiments, a rainfall effect is created as device stand 600 illuminates each portion of device stand 600 for half of a second after the preceding portion. That is, the manner in which device stand 600 illuminates the various portions of device stand 600 makes it appear that light is falling down the length of device stand 600 in the same manner that rain falls. In some embodiments, device stand 600 projects an indication of rain from a location corresponding to the back of device stand 600 onto a wall and/or table. For example, device stand 600 casts a projection of a depiction of raindrops, clouds, and/or thunderbolts onto a wall and/or table near device stand 600.

A period of time of expires between FIG. 6K and FIG. 6L. At FIG. 6L, computer system 604 is in the inactive state. As illustrated in FIG. 6L, while computer system 604 is in the inactive state, computer system 604 displays photo 620 that is a photo of a series of photos (e.g., from a photo library of computer system 604 and/or from a photo library of a computer system external to computer system 604). Photo 620 depicts an outdoor landscape including a tree, grass, and the sun. The leaves of the tree included in photo 620 are a color C, the trunk of the tree included in photo 620 is a color D, the grass of the environment included in photo 620 is a color E and the sun included in photo 620 if a color F.

At FIG. 6L, device stand 600 illuminates the various portions of device stand 600 in various colors based on the colors included in photo 620. More specifically, device stand 600 illuminates the first portion of device stand 600 with color C, the second portion of device stand 600 with color D, the third portion of device stand 600 with color E, and the fourth portion of device stand 600 with color F. The color of each of the portions of device stand 600 are based on the colors included in photo 620. For example, color C (e.g., the color of the illumination of the first portion of device stand 600) represents the color of the tree leaves in photo 620 (e.g., light green), color D (e.g., the color of the illumination of second portion of device stand 600) represents the color of the tree trunk in photo 620 (e.g., brown), color E (e.g., the color of the illumination of third portion of device stand 600) represents the color of the grass in photo 620 (e.g., dark green), and color F (e.g., the color of the illumination of the forth portion of device stand 600) represents the color of the sun in photo 620 (e.g., yellow).

At FIG. 6M, computer system 604 detects that a predetermined period of time (e.g., 30 seconds to 5 minutes) has elapsed since computer system 604 initially displayed photo 620. As illustrated in FIG. 6M, in response to detecting that the predetermined period of time has elapsed since computer system 604 initially displayed photo 620, computer system 604 displays photo 622 (e.g., the next photo in the series of photos). Photo 622 is a photo of a Christmas tree and two gifts. At FIG. 6M, similarly to FIG. 6L, device stand 600 illuminates the various portions of device stand 600 with colors that are included in photo 622. More specifically, at FIG. 6M, device stand 600 illuminates the first portion of device stand 600 with color F, the second portion of device stand 600 with color D, the third portion of device stand 600 with color G, and the fourth portion of device stand 600 with color H. Color F represents the color of the Christmas tree in photo 622 (e.g., dark green), color D represents the color of the Christmas tree trunk in photo 622 (e.g., brown), color G represents the color of the gift positioned to the left in photo 622 (e.g., purple), and color H represents the color of the gift positioned to the right in photo 622 (e.g., blue).

A period of time elapses between FIG. 6M and FIG. 6N. At FIG. 6N, computer system 604 generates and displays calendar notification 624. Calendar notification 624a includes an indication of an upcoming event pertaining to a schedule of a user of computer system 604. More specifically, calendar notification 624a indicates that a flight of the user departs in one hour. At FIG. 6N, device stand 600 detects that computer system 604 generates and/or displays calendar notification 624a. At FIG. 6N, because device stand 600 detects that computer system 604 generates and/or displays calendar notification 624a, device stand 600 illuminates the fourth portion of device stand 600 with the color I. Device stand 600 illuminates the fourth portion of device stand 600 to alert the subject of the pending calendar notification at computer system 604. In some embodiments, device stand 600 continues to illuminate the fourth portion of device stand 600 until computer system 604 detects an input corresponding to selection of calendar notification 624a.

At FIG. 6O, computer system 604 detect voice input 605o. Voice input 605o includes instructions for a virtual assistant of computer system 604 to order a ride to the airport. As illustrated in FIG. 6O, in response to detecting voice input 605o, computer system 604 displays virtual assistant indicator 626. Computer system 604 displays virtual assistant indicator 626 to indicate that computer system 604 detects voice input 605o.

At FIG. 6O, a determination is made that computer system 604 detects voice input 605o. At FIG. 6O, based on the determination that computer system 604 detects voice input 605o, device stand 600 illuminates the third portion and the fourth portion of device stand 600 in color J. Device stand 600 illuminates the third portion and the fourth portion of device stand 600 to indicate that device stand 600 detects voice input 605o. In some embodiments, device stand 600 detects voice input 605o in conjunction with device stand 600 detecting voice input 605o.

FIG. 6O includes arrows 628. Arrows 628 indicate that, in some embodiments, device stand 600 increases or decreases the number of portions of device stand 600 that are illuminated based on a determination that one or more audible characteristics of voice input 605o changes. For example, based on a determination that voice input 605o increases in tone and/or volume, device stand 600 illuminates four portions of device stand 600 to indicate the increase in the tone and/or volume of voice input 605o. As another example, based on a determination that the tone and/or volume of voice input 605o decreases, device stand 600 illuminates only the fourth portion of device stand 600 to indicate the decrease in the tone and/or volume of voice input 605o. In some embodiments, device stand 600 illuminates the various portions of device stand 600 with colors corresponding to the colors of virtual assistant indicator 626. In some embodiments, computer system 604 and/or device stand 600 processes voice input 605o locally. In some embodiments, voice input 605o is processed remotely.

At FIG. 6P, in response to detecting voice input 605o, computer system 604 orders a ride to the airport. As part of ordering the ride to the airport, computer system 604 outputs voice output 630. Voice output 630 indicates that computer system 604 is ordering the ride to the airport. As illustrated in FIG. 6P, computer system 604 continues to display virtual assistant indicator 626 while computer system 604 outputs voice output 630 to indicate that computer system 604 is responding to voice input 605o via the virtual assistant. As illustrated in FIG. 6P, because computer system 604 orders the ride to the airport, computer system 604 displays rideshare user interface 632. Rideshare user interface 632 includes information regarding the ride that computer system 604 ordered. At FIG. 6P, rideshare user interface 632 includes the destination of the ride (e.g., the airport), the amount of time until the ride arrives (e.g., 5 minutes), a map of a route of the ride, and the duration of the transportation (e.g., 12 minutes).

At FIG. 6P, device stand 600 detects that computer system 604 is outputting voice output 630. At FIG. 6P, because device stand 600 detects that computer system 604 is outputting voice output 630, device stand 600 illuminates the third portion and the fourth portion of device stand 600 in color J. Device stand 600 illuminates the third and fourth portion of device stand 600 to indicate that computer system 604 is currently outputting voice output 630.

FIG. 6P includes arrows 628 to demonstrate that, in some embodiments, device stand 600 increases or decreases the number of portions of device stand 600 that are illuminated based on a determination that one or more audible characteristics of voice output 630 changes. For example, based on a determination that the tone and/or volume of voice output 630 increases, device stand 600 illuminates four portions of device stand 600 to represent the increase in the tone and/or volume of voice output 630. As another example, based on a determination that the tone and/or volume of voice output 630 decreases, device stand 600 illuminates only the fourth portion of device stand 600 to indicate the decrease in the tone and/or volume of voice output 630.

At FIG. 6Q, a determination is made that the ride that was ordered is enroute to pick up the subject. As illustrated in FIG. 6Q, based on the determination that the ride that was ordered is enroute to the subject, computer system 604 displays pick-up user interface 634. At FIG. 6Q, pick-up user interface 634 includes the time until the ride arrives, the name of the driver, the color of the car, the license plate number of the car, and a progress bar indicator that represents the distance the car is from the location of the subject. As illustrated in FIG. 6Q, computer system 604 displays the progress bar indicator as approximately one-third complete indicating that the ride is approximately one-third of the way to the location of the subject.

At FIG. 6Q, a determination is made that the ride is five minutes away from the location of the subject. At FIG. 6Q, because the determination is made that the ride is five minutes away from the location of the subject, device stand 600 illuminates the third portion and the fourth portion of device stand 600 with color A. That is, device stand 600 illuminates the third portion and the fourth portion of device stand 600 to indicate to the subject the urgency and time-sensitive nature of the ride arriving to pick up the subject. At FIG. 6Q, device stand 600 illuminates the two portions of device stand 600 to represent a medium-level urgency to the subject.

At FIG. 6R, a determination is made that the ride that was ordered is one minute away from the location of the subject. At FIG. 6R, because the determination is made that the ride that was ordered is one minute away from the location of the subject, computer system 604 updates pick-up user interface 634 to indicate that the ride will arrive in one minute. More specifically, computer system 604 updates the display of the progress bar indicator as approximately three-quarters filled. In some embodiments, the tracking of the ride as the ride is enroute to the subject is a live event (e.g., an ongoing and/or current event). In such embodiments, computer system 604 updates the display of pick-up user interface 634 as computer system 604 detects updates to the live event.

At FIG. 6R, because the determination is made that the ride that was ordered is one minute away from the subject, device stand 600 illuminates the first portion, the second portion, the third portion, and the fourth portion of device stand 600 in color A. As discussed above, device stand 600 illuminates the various portions of device stand 600 to indicate the urgency and time-sensitive nature of the ride arriving to pick up the subject. At FIG. 6R, because the ride is closer to the location of the subject than the ride was at FIG. 6Q, device stand 600 illuminates more of device stand 600. That is, as updates to the live event occur, device stand 600 changes the number of portions of device stand 600 that are illuminated to indicate an urgency of the live event. Put a different way, more portions of device stand 600 are illuminated as the urgency of a live event increases. In some embodiments, device stand 600 decreases the number of portions of device stand 600 that are illuminated as the urgency of a live event decreases. In some embodiments, device stand 600 decreases the number of portions of device stand 600 that are illuminated as the urgency of a live event increases.

At FIG. 6S, a determination is made that the ride that was ordered has arrived at the location of the subject. At FIG. 6S, because the determination is made that the ride that was ordered has arrived at the location of the subject, computer system 604 updates pick-up user interface 634 to indicate that the ride has arrived at the location of the subject. At FIG. 6S, as part of updating pick-up user interface 634, computer system 604 displays the progress bar indicator as completely filled in. At FIG. 6S, device stand 600 continues to illuminate the first portion, the second portion, the third portion, and the fourth portion of device stand 600 as a technique to draw the attention of the subject to the arrival of the ride and the urgency related to the time-sensitive nature of the arrival. At FIG. 6S, computer system 604 detects tap input 605s directed to add control 634a. It should be recognized that tap input 605s is an example of a selection input of add control 634a and that other types of inputs can be used such as an air gesture and/or a voice request to send a message.

As illustrated in FIG. 6T, in response to detecting tap input 605s directed to add control 634a, computer system 604 displays message recipient user interface 636a. Message recipient user interface 636a includes a list of names (e.g., John, Bob, Alice, and Derek) of users for which computer system 604 can create a message for. At FIG. 6T, computer system 604 detects tap input 605t directed to the name John. In some embodiments, the names included in the list of names are users that are registered with device stand 600 and/or computer system 604. In some embodiments, the names included in the list of names are users that are registered with a home that is registered to device stand 600. In some embodiments, device stand 600 ceases to illuminate the first portion, the second portion, the third portion, and the fourth portion of device stand 600 in response to detecting tap input 605s. In some embodiments, device stand 600 ceases to illuminate the first portion, the second portion, the third portion, and the fourth portion of device stand 600 based on the ride arriving.

As illustrated in FIG. 6U, in response to detecting tap input 605t directed to the name John, computer system 604 displays create message user interface 636b. As illustrated in FIG. 6U, create message user interface 636b includes “Write a message to John” with a blank space below. At FIG. 6U, computer system 604 is creating message 638 based on detection of movement of input 605u. That is, at FIG. 6U, the subject is in the process of writing a message to John using a finger of the subject. In some embodiments, the user creates message 638 via a voice and/or typing input (e.g., via a keyboard).

At FIG. 6V, computer system 604 has completed creating message 638, which reads “See you tomorrow!” At FIG. 6V, computer system 604 detects swipe down input 605v. It should be recognized that swipe down input 605v is an example of a movement input and that other types of inputs can be used such as an air gesture and/or a voice request to store message 638.

At a time between FIG. 6V and FIG. 6W, computer system 604 is de-coupled from device stand 600. Before FIG. 6W, in response to detecting swipe down input 605v, computer system 604 transmits data corresponding to message 638 to device stand 600. At FIG. 6W, in response to receiving the data corresponding to message 638, device stand 600 illuminates the fourth portion (e.g., the portion of device stand 600 that corresponds to indicator 600d) of device stand 600 in color K. Device stand 600 illuminates the fourth portion of device stand 600 in color K to indicate that device stand 600 is storing a pending message for John.

FIGS. 6X1-6X4 illustrate a process of illuminating various portions of device stand 600 that is representative of device stand 600 transmitting data corresponding to message 638 to computer system 640. As device stand 600 transmits data corresponding to message 638 to computer system 640, device stand 600 progressively illuminates portions of device stand 600 in a bottom-up manner. Device stand 600 illuminates portions of device stand 600 in a bottom-up manner to mimic the transmission of the data from device stand 600 to a computer system coupled to device stand 600.

FIG. 6X1 depicts a first frame of the process of illuminating the various portions of device stand 600 representative of device stand 600 transmitting data corresponding to message 638 to computer system 640 At FIG. 6X1, computer system 640 (e.g., a second computer system) is coupled to device stand 600. Computer system 640 is a personal device of a subject by the name of Sara. At FIG. 6X1, device stand 600 detects the coupling of computer system 640 to device stand 600. At FIG. 6X1, in response to detecting the coupling of computer system 640 to device stand 600, device stand 600 transmits data corresponding to message 638 to computer system 640. At FIG. 6X1, as part of transmitting data corresponding to message 638 to computer system 640, device stand 600 begins to illuminate various portions of device stand 600 to mimic the transmission of data from device stand 600 to computer system 640. More specifically, at FIG. 6X1, device stand 600 illuminates the fourth portion of device stand 600 (e.g., the portion of device stand 600 that corresponds to indicator 600d).

FIG. 6X2 depicts a second frame of the process of illuminating various portions of device stand 600 representative of device stand 600 transmitting data corresponding to message 638 to computer system 640. At FIG. 6X2, device stand 600 ceases to illuminate the fourth portion of device stand 600 and illuminates the third portion of device stand 600 (e.g., the portion of device stand 600 directly above the fourth portion) in color K.

FIG. 6X3 depicts a third frame of process of illuminating various portions of device stand 600 representative of device stand 600 transmitting data corresponding to message 638 to computer system 640. At FIG. 6X3, device stand 600 ceases to illuminate the third portion of device stand 600 and illuminates the second portion of device stand 600 (e.g., the portion of device stand 600 directly above the third portion) in color K.

FIG. 6X4 depicts a fourth frame of process of illuminating various portions of device stand 600 representative of device stand 600 transmitting data corresponding to message 638 to computer system 640. At FIG. 6X4, device stand 600 ceases to illuminate the second portion of device stand 600 and illuminates the first portion of device stand 600 (e.g., the portion of device stand 600 directly above the second portion) in color K.

At FIG. 6Y, device stand 600 completes the process of transmitting the data corresponding to message 638. At FIG. 6Y or before transmitting the data corresponding to message 638, a determination is made that message 638 does not correspond to the user of computer system 640. As illustrated in FIG. 6Y, because the determination is made that message 638 does not correspond to the user of computer system 640, computer system 640 displays message 642, “Message not viewable” and does not display message 638. In some embodiments, message 642 is, corresponds to, and/or is a result of the data sent to computer system 640 from device stand 600. At FIG. 6Y, as part of displaying message 642, computer system 640 moves the display of message 642 up and down. Computer system 640 is not able to access the content of message 638 due to the determination being made that message 638 does not correspond to the user of computer system 640 (e.g., Sara is not the intended recipient of message 638). At FIG. 6Y, device stand 600 illuminates the fourth portion of device stand 600 to indicate that the content of message 638 has not been accessed and remains stored by device stand 600.

At a time between FIG. 6Y and FIG. 6Z, computer system 640 is decoupled from device stand 600. Additionally, at a time between FIGS. 6Y and 6Z, device stand 600 receives and stores three additional messages and/or notifications. Examples of messages and/or notifications that device stand 600 receives and stores includes incoming calls, text messages, alerts, timers, and notifications pertaining to various application. The first notification and/or message that device stand 600 receives is a second message that corresponds to John. Accordingly, at FIG. 6Z, device stand 600 illuminates the third portion of device stand 600 with color K (e.g., the color that corresponds to John) to represent the second message for John. The second and third notifications and/or messages that device stand 600 receives correspond to computer system 604. Accordingly, at FIG. 6Z, device stand 600 illuminates the first portion and the second portion of device stand 600 in color A (e.g., intended for the user of computer system 604) to represent the second and third message and/or notifications. Device stand 600 illuminates the various portions of device stand 600 based on the temporal order in which device stand 600 receives and/or generates notifications. For example, because the fourth notification is the latest notification that device stand 600 generates and/or receives, device stand 600 illuminates the first portion (e.g., the highest portion of device stand 600) in a manner that is representative of the fourth notification.

At FIG. 6Z, device stand 600 continues to illuminate the fourth portion of device stand 600 with color K to indicate that device stand 600 continues to store message 638 that corresponds to John. Accordingly, the illumination of the fourth portion of device stand 600 represents message 638 while the illumination of the third portion of device stand 600 represents a separate message and/or notification intended for John. In some embodiments, device stand 600 illuminates the various portions of device stand 600 in different colors based on an application that generated and/or provided the notification. In some embodiments, device stand 600 illuminates the various portions of device stand 600 in a blinking manner if the corresponding message and/or notification has not yet been viewed or opened by the intended recipient.

At FIG. 6AA, a determination is made that computer system 644 is within a threshold distance (e.g., 0-10 feet) of device stand 600. Computer system 644 is the personal device of John (e.g., the intended recipient of message 638). Based on the determination that computer system 644 is within the threshold distance of device stand 600, device stand 600 ceases to illuminate the first and second portion of device stand 600. That is, in response to computer system 644 being within close proximity to device stand 600, device stand 600 illuminates various portions of device stand 600 in a manner that corresponds to notifications of computer system 644 and ceases to illuminate various portions of device stand 600 in a manner that that corresponds to notifications and/or messages intended for computer systems other than computer system 644. In some embodiments, while computer system 644 is not coupled to device stand 600, device stand 600 changes the illumination of various portions of device stand 600 in response to detecting that computer system 644 performs an operation.

As illustrated at FIG. 6AB, computer system 644 (e.g., the computer system of John) is coupled to device stand 600. At FIG. 6AB, a determination is made that computer system 644 is coupled to device stand 600. At FIG. 6AB, because the determination is made that computer system 644 is coupled to device stand 600, device stand 600 transmits data corresponding to message 638 to computer system 644. In some embodiments, device stand 600 transmits data that corresponds to message 638 to computer system 644 based on a determination that computer system 644 corresponds to the intended recipient of message 638.

At FIG. 6AB, a determination is made that computer system 644 corresponds to (e.g., is owned by and/or is registered to) the intended recipient of message 638. As illustrated at FIG. 6AB, in response to computer system 644 receiving the data corresponding to message 638 and based on the determination that computer system 644 corresponds to the intended recipient of message 638, computer system 644 displays message preview indicator 646. As illustrated in FIG. 6AB, message preview indicator 646 includes an indication of the sender (e.g., Jane) and the recipient (e.g., John) of message 638. It should be noted that, prior to computer system 644 displaying message preview indicator 646, device stand 600 illuminates the various portions of device stand 600 in a manner that mimics the transmission of data corresponding to message 638 from device stand 600 to computer system 644 and described above with respect to FIGS. 6X1-6X4.

At FIG. 6AB, device stand 600 illuminates the fourth portion of device stand 600 in the color K. The illumination of the fourth portion of device stand 600 is representative of the second message intended for John that device stand 600 received and stored between FIGS. 6X and 6Z. Device stand 600 represents the second message for John by illuminating the fourth portion of device stand 600 and not the third portion of device stand 600 at FIG. 6AB because the second message for John is the only pending notification that corresponds to computer system 644. In some embodiments, after transmitting the data that corresponds to message 638 to computer system 644, device stand 600 transmits data corresponding to the second message for John to computer system 644 while computer system 644 is coupled to device stand 600. At FIG. 6AB, computer system 644 detects tap input 605ab directed to message preview indicator 646. It should be recognized that tap input 605ab is an example of a selection input of message preview indicator 646 and that other types of inputs can be used such as an air gesture and/or a voice request to open message 638.

As illustrated in FIG. 6AC, in response to detecting tap input 605ab, computer system 644 displays message content user interface 636c, which includes the content of message 638 (e.g., “See you tomorrow!”) and the author of message 638 (e.g., “Message from Jane”). At FIG. 6AC, device stand 600 continues to illuminate the fourth portion of device stand 600 to represent the unopened second message for John that is stored by device stand 600.

A period of time elapses between FIG. 6AC and FIG. 6AD. Between FIGS. 6AC and 6AD, device stand 600 enters the inactive state and device stand 600 and computer system 644 generates and/or receives calendar notification 660. Accordingly, as illustrated in FIG. 6AD, computer system 644 displays a representation of calendar notification 660 within displaying inactive state user interface 608.

At FIG. 6AD, device stand 600 detects that computer system 644 generates and/or receives calendar notification 660. In response to detecting that computer system 644 generates and/or receives calendar notification 660, device stand 600 illuminates the fourth portion of device stand with color L. In some embodiments, color L represents a calendar notification that is specific to the user John. Recall that, at FIG. 6N, device stand 600 illuminates the fourth portion of device stand 600 in color I to indicate that computer system 604 generated and/or received calendar notification 624a intended for Jane. That is, device stand 600 illuminates the various portions of device stand 600 differently (e.g., in different colors and/or with different intensities) when different computer systems receive and/or generate the same type of notification. In some embodiments, device stand 600 illuminates the various portions of device stand 600 in the same manner when different computer systems receive and/or generate the same type of notification.

FIG. 6AE illustrates schematics 650-658 that depict various configurations of lighting sources that can be integrated within device stand 600. Schematic 650 is an exemplary embodiment of device stand 600 where device stand 600 includes four light sources in a vertical arrangement. Schematic 652 is an exemplary embodiment of device stand 600 where device stand 600 includes a single light source around a portion or the entirety of the base of device stand 600. Device stand 600 depicted in schematic 652 illuminates a portion of the single light source or the entirety of the single light source in response to detecting events such as an external computer system generating and/or receiving a notification. Schematic 654 is an exemplary embodiment of device stand 600 where device stand 600 includes a single light source near the bottom of device stand 600.

Schematics 656-658 depict the different manners in which device stand 600 can illuminate the surrounding environment of device stand 600. The hatched portion in schematic 656 and schematic 658 represents the areas of illumination by device stand 600. Specifically, schematic 656 depicts device stand 600 as illuminating one or more surfaces underneath device stand 600 such as a table and/or floor, and schematic 658 depicts device stand 600 as illuminating one or more surfaces behind device stand 600, such as a wall. In some embodiments, the exemplary embodiments of device stand 600 in schematics 656-658 are the same (e.g., have the same light source configuration). In some embodiments, the exemplary embodiments of device stand 600 in schematics 656-658 are different (e.g., have different configurations of light sources). In some embodiments, device stand 600 illuminates an area in the manner depicted by schematic 656 and/or schematic 658 (e.g., on one side, underneath and/or behind device stand 600) when projecting images and/or colors relating to weather, photos, music, a morning scene, and/or a night scene. In some embodiments, device stand 600 illuminates a surface to the side, underneath, and/or to the rear of device stand 600 in response to detecting an individual, as described with respect to FIGS. 6C-6D, and/or in response to detecting the output of an alarm (e.g., alarm clock feature), as described with respect to FIGS. 6E-6I. In some embodiments, device stand 600 illuminates a surface to the side, underneath, and/or to the rear of device stand 600 as part of mimicking colors from photos, as described with respect to FIGS. 6L-6M, and/or mimicking weather conditions (e.g., projecting raindrops from device stand 600 onto a nearby table and/or wall) as described with respect to FIG. 6K.

It should be noted that the various types of inputs illustrated and described throughout FIGS. 6A-6AE are merely exemplary. The types of inputs described and illustrated throughout FIGS. 6A-6AE can be various other types of inputs. For example, in some embodiments, tap input 605s is a gaze input that is directed at add control 634a and/or a voice command that includes an utterance that identifies add control 634a. As another example, in some embodiments, tap input 605i is an air gesture (e.g., pinch gesture and/or swipe gesture) while stop control 614a is visually emphasized.

FIG. 7 is a flow diagram illustrating a process (e.g., process 700) for providing an output in accordance with some embodiments. Some operations in process 700 are, optionally, combined, the orders of some operations are, optionally, changed, and some operations are, optionally, omitted.

As described below, process 700 provides an intuitive way for providing an output. Process 700 reduces the cognitive burden on a user, thereby creating a more efficient human-machine interface. For battery-operated computing devices, enabling a user to interact with such devices faster and more efficiently conserves power and increases the time between battery charges.

In some embodiments, process 700 is performed at a device stand (e.g., 600) that includes (and/or is in communication with, such as wireless communication and/or wired communication) one or more input devices (e.g., a physical input mechanism, a hardware input mechanism, a camera, a touch-sensitive surface, a microphone, a camera, a depth sensor, an accelerometer, a temperature sensor, and/or a heart monitor) and one or more output devices (e.g., a light source, a display generation component, an audio generation component, and/or a haptic output device). In some embodiments, the external device is a watch, a phone, a tablet, a fitness tracking device, a processor, a head-mounted display (HMD) device, a communal device, a media device, a speaker, a television, and/or a personal computing device. In some embodiments, the device stand includes a hardware component that is configured to have an external device be coupled to the hardware component. In some embodiments, the device stand includes a hardware component that is configured to couple and/or be coupled with an external device be coupled to the hardware component. In some embodiments, the device stand includes a hardware component that is used to hold an external device. In some embodiments, the device stand includes a hardware component that is configured to support an external device. In some embodiments, the display generation component includes a display screen, a projector, and/or a touch-sensitive display. In some embodiments, the audio generation component includes a speaker, a smart speaker, a home theater system, a soundbar, a headphone, an earphone, an earbud, a television speaker, an augmented reality headset speaker, an audio jack, an optical audio output, a Bluetooth audio output, and/or a HDMI audio output. In some embodiments, the physical input mechanism includes a hardware input mechanism, a rotatable input mechanism, a crown, a knob, a dial, a physical slider, and/or a hardware button.

The device stand detects (702), via the one or more input devices of the device stand (e.g., 600), a voice input (e.g., 605o) (e.g., a verbal input, an audio input, a verbal utterance, a sound, an audible request, an audible command, and/or an audible statement), wherein the device stand (e.g., 600) includes an attachment point (e.g., 602) (e.g., a magnetic and/or mechanical attachment) that is configured to attach to an external device (e.g., 604 and/or 644) and hold the external device in a respective pose (e.g., a fixed pose or a dynamic pose, optionally a pose that would not be maintained by the external device if the external device were not attached to the attachment point) relative to a physical environment. In some embodiments, the voice input is directed to the device stand (e.g., the voice input includes an indication and/or identification of the device stand). In some embodiments, the voice input is not directed to the device stand (e.g., the voice input does not include an indication and/or identification of the device stand). In some embodiments, the voice input is directed to the external device that is coupled to the device stand. In some embodiments, the voice input is directed to a subject in an environment (e.g., a user, a person, an individual, an animal, and/or an external device). In some embodiments, when the external device is attached to the attachment point, the device stand provides power to the external device and/or communicates with the external device (e.g., with a wired or wireless data connection).

In response to detecting the voice input (e.g., 605o), the device stand outputs (704), via the one or more output devices of the device stand (e.g., 600), a respective output (e.g. illumination of 600a, 600b, 600c and/or 600d) that is generated based on (e.g., is a response to the voice input or is otherwise generated based on the voice input) the voice input (e.g., an audio output, a haptic output, and/or a visual output). In some embodiments, the device stand detects the voice input while the external device is not attached to the device stand. In some embodiments, the device stand detects the voice input while the external device is coupled to the device stand. In some embodiments, the device stand outputs the respective output while the external device is attached to the device stand. In some embodiments, the device stand outputs the respective output while the external device is not attached to the device stand. In some embodiments, the device stand outputs an output in response to detecting a non-voice input (e.g., a tap input, a selection input, a swipe input, a hold-and-drag input, a gaze input, an air gesture, mouse movement, and/or a mouse click). In some embodiments, the respective output is a combination of an audio output, a haptic output, and/or a visual output. In some embodiments, content of and/or an output device used for the respective output is dependent on who said the audio input (e.g., the respective output includes first content when the device stand detects that the audio input is from a first subject and the respective output includes second content, different from the first content, when the device stand detects that the audio input is from a second subject different from the first subject). In some embodiments, content of and/or an output device used for the respective output is dependent on a topic of the audio input (e.g., the respective output includes first content when the device stand detects that the audio input has a first topic and the respective output includes second content, different from the first content, when the device stand detects that the audio input has a second topic different from the first topic). In some embodiments, the device stand detects the audio input while the device stand is in a sleep state. In some embodiments, the device stand suspends outputting the respective output. In some embodiments, the device stand ceases outputting the respective output. In some embodiments, the color, size, blinking frequency, and/or brightness of the illumination is based on the voice input. In some embodiments, the color, size, blinking frequency, and/or brightness of the illumination is based on environment of the user and/or device stand. In some embodiments, the color, size, blinking frequency, and/or brightness of the illumination is based on the speaker of the voice input. In some embodiments, the color, size, blinking frequency, and/or brightness of the illumination is based a time of day. A device stand outputting a respective output that is generated based on a detected voice input allows the device stand to tailor the output of the respective output such that the respective output can provide context regarding the voice input such as content included in the voice input and/or one or more audio characteristics of the voice input, thereby performing an operation when a set of conditions has been met without requiring further user input and/or providing improved feedback.

In some embodiments, the device stand (e.g., 600) includes one or more light sources (e.g., 600a, 600b, 600c, and/or 600d) (e.g., a single light source such as a single light or an array of light sources such as an array of light bulbs). In some embodiments, outputting the respective output (e.g. illumination of 600a, 600b, 600c and/or 600d) that is generated based on the voice input (e.g., 605o) includes illuminating, via the set of one or more light sources, a portion of the device stand, that includes the attachment point (e.g., 602) (e.g., based on the voice input). In some embodiments, outputting the respective output that is generated based on the voice input includes illuminating, via the set of one or more light sources, a portion, of the device stand, that does not include the attachment point (e.g., with or without illuminating the portion that includes the attachment point). In some embodiments, illuminating the portion that does not include the attachment point is based on the voice input. Illuminating a portion of a device stand that includes an attachment point in response to detecting a voice input allows the device stand to perform an illumination operation that indicates that the voice input is detected without having to cause display of user interface objects on an external device, thereby providing improved visual feedback and/or performing an operation when a set of conditions has been met without requiring further user input.

In some embodiments, illuminating the portion that includes the attachment point (e.g., 602) includes, while illuminating the portion that includes the attachment point (e.g., and/or while detecting the voice input) in a first manner (e.g., brightness, color, and/or size of illumination), detecting, via the one or more input devices, a change in a set of one or more characteristics of the voice input (e.g., 605o) (e.g., a change in volume, tone, speed, and/or clarity of the voice input). In some embodiments, in response to detecting the change in the set of one or more characteristics of the voice input and in accordance with a determination that the set of one or more characteristics of the voice input satisfy a first set of one or more criteria (e.g., the voice input gets louder, the voice input gets quieter, the voice input gets less clear, the voice input gets more clear, the voice input speeds up, the voice input slows down, and/or the tone of the voice input becomes more intense), the device stand changes, via the one or more light sources (e.g., 600a, 600b, 600c, and/or 600d), the illumination of, the portion that includes the attachment point to a second manner (e.g., increasing brightness, decreasing brightness, changing color, increasing size, decreasing size, powering on the set of one or more light sources, and/or powering off the set of one or more light sources) different from the first manner (e.g., as described above in reference to FIG. 6O) and in accordance with a determination that the set of one or more characteristics of the voice input satisfy a second set of one or more criteria (e.g., the voice input gets louder, the voice input gets quieter, the voice input gets less clear, the voice input gets more clear, the voice input speeds up, and/or the voice input slows down, and/or the tone of the voice input becomes more intense) different from the first set of one or more criteria, the device stand changes, via the one or more light sources, the illumination of the portion that includes the attachment point in a third manner (e.g., increasing the brightness, decreasing the brightness, changing the color, increasing the size, decreasing the size, powering on the set of one or more light sources, and/or powering off the set of one or more light sources) different from the first manner and the second manner (e.g., as described above in reference to FIG. 6O). In some embodiments, the device stand does not change illumination of the portion that includes the attachment point in response to detecting that the set of one or more characteristics of the voice input do not change. In some embodiments, the external device is not attached to the device stand while the device stand changes the illumination of the portion that includes the attachment point. Changing illumination of a portion of a device stand when a set of prescribed conditions is met (e.g., when one or more characteristics of a voice input satisfies a set of one or more criteria) allows the device stand to provide an indication regarding a tone, volume level, clarity, and/or other audible characteristic of the voice input, thereby performing an operation when a set of conditions has been met without requiring further user input.

In some embodiments, outputting the respective output (e.g. illumination of 600a, 600b, 600c and/or 600d) that is generated based on the voice input (e.g., 605o) includes illuminating, via the set of one or more light sources (e.g., 600a, 600b, 600c, and/or 600d), a portion (e.g., an area, a surface, a region, and/or an object), of an environment, that is under the device stand (e.g., 600) (and/or the attachment point). In some embodiments, outputting the respective output that is generated based on the voice input includes illuminating, via the set of one or more light sources, a portion, of the environment, that is above and/or to the side of the device stand and/or the attachment point (e.g., with or without illuminating the portion that is under the device stand and/or the attachment point). In some embodiments, illuminating the portion that is above and/or to the side of the device stand and/or the attachment point is based on the voice input. In some embodiments, outputting the respective output that is generated based on the voice input includes illuminating, via the set of one or more light sources, in a direction that is directed towards a surface that supports the device stand (e.g., gravity causes the device stand to rest on the surface and/or the device stand is attached to the surface using a physical and/or magnetic attachment mechanism). In some embodiments, outputting the respective output that is generated based on the voice input includes illuminating, via the set of one or more light sources, an area beneath the external device while the external device is attached to the device stand. In some embodiments, the device stand illuminates the portion of the environment that is under the device stand based on the voice input (e.g., based on a volume, tone, and/or content of the voice input). Illuminating a portion of an environment that is under a device stand in response to detecting a voice input allows the device stand to provide an indication that the voice input was detected in a manner that is not overly distracting to a user and does not block a view of an external device that is attached to the device stand, thereby providing improved feedback and/or performing an operation when a set of conditions has been met without requiring further user input.

In some embodiments, outputting the respective output (e.g. illumination of 600a, 600b, 600c and/or 600d) that is generated based on the voice input (e.g., 605o) includes illuminating, via the set of one or more light sources (e.g., 600a, 600b, 600c, and/or 600d), a portion (e.g., an area, a surface, a region, and/or an object), of an environment, that is behind the device stand (e.g., 600) (and/or the attachment point) (e.g., based on the voice input). In some embodiments, outputting the respective output that is generated based on the voice input includes illuminating, via the set of one or more light sources, in a direction that is directed towards an opposite side of the device stand than a side of the device stand that includes the attachment point (e.g., behind the device stand and/or in a direction that that is opposite of the external device when the external device is attached to the device stand). In some embodiments, outputting the respective output that is generated based on the voice input includes illuminating, via the set of one or more light sources, an area behind the external device while the external device is attached to the device stand. In some embodiments, the device stand illuminates the portion of the environment that is behind the device stand based on the voice input (e.g., based on a volume, tone, and/or content of the voice input). Illuminating a portion of an environment that is behind a device stand in response to detecting a voice input allows the device stand to perform an illumination operation that provides information regarding the voice input in a manner that does not obstruct a view of an external device that is attached to the device stand, thereby providing improved feedback and/or performing an operation when a set of conditions has been met without requiring further user input.

In some embodiments, outputting the respective output (e.g. illumination of 600a, 600b, 600c and/or 600d) that is generated based on the voice input (e.g., 605o) includes illuminating, via the set of one or more light sources (e.g., lights that illuminate portions of device stand 600 corresponding to 600a, 600b, 600c, and/or 600d), a portion (e.g., an area, a surface, a region, and/or an object), of an environment, that is in front of the device stand (e.g., 600) (and/or the attachment point). In some embodiments, outputting the respective output that is generated based on the voice input includes illuminating, via the set of one or more light sources, in a direction that is directed towards a common side of the device stand as a side of the device stand that includes the attachment point (e.g., in front of the device stand and/or in a direction is the same direction as the external device when the external device is attached to the device stand). In some embodiments, outputting the respective output that is generated based on the voice input includes illuminating, via the set of one or more light sources, in a direction that is directed towards a side of the device stand that includes the attachment point (e.g., in front of the device stand and/or in a direction that that is the same direction as the external device when the external device is attached to the device stand). In some embodiments, outputting the respective output that is generated based on the voice input includes illuminating, via the set of one or more light sources, an area in front of the external device while the external device is attached to the device stand. In some embodiments, the device stand illuminates the portion of the environment that is in front of the device stand based on the voice input (e.g., based on a volume, tone, and/or content of the voice input). Illuminating a portion of an environment that is in front of a device stand in response to detecting a voice input allows the device stand to illuminate the environment in a manner such that a user can concurrently view content being displayed via an external device that is attached to the device stand and the illumination that is output by the device stand, thereby providing improved visual feedback and/or performing an operation when a set of conditions has been met without requiring further user input.

In some embodiments, outputting the respective output (e.g. illumination of 600a, 600b, 600c and/or 600d) that is generated based on the voice input (e.g., 605o) includes illuminating, via the set of one or more light sources (e.g., lights that illuminate portions of device stand 600 corresponding to 600a, 600b, 600c, and/or 600d), a portion (e.g., an area, a surface, a region, and/or an object), of an environment, around (e.g., partially around or entirely around) a base (e.g., a portion of the device stand that is in contact with a surface that supports the device stand and/or a lower portion of the device stand) of the device stand (e.g., 600). In some embodiments, the portion of the device stand around the base is a majority of the portion of the device stand that is in contact with the surface or a minority of the portion of the device stand is in contact with the surface. In some embodiments, gravity causes the base of the device stand to rest upon the surface. Illuminating a portion of an environment that is around a base of a device stand in response to detecting a voice input allows the device stand to perform an illumination operation that provides information regarding the voice input in a manner that does not obstruct the view of an external device that is attached to the device stand, thereby providing improved feedback and/or performing an operation when a set of conditions has been met without requiring further user input.

In some embodiments, the attachment point (e.g., 602) includes a set of one or more magnets (e.g., permanent magnets, temporary magnets, and/or electromagnets) configured to magnetically attach (and/or magnetically couple) the external device (e.g., 604 and/or 644) to the device stand (e.g., 600). In some embodiments, a portion of the device stand different from the attachment point includes the set of one or more magnets. In some embodiments, the external device includes a set of one of more magnets configured to magnetically attached to the attachment point of the device stand. Outputting a respective output at a device stand that includes a set of one or more magnets configured to attach to an external device allows the device stand to illuminate an environment while a user can seamlessly magnetically attach the external device to an attachment point of the device stand, thereby providing improved feedback.

In some embodiments, the device stand (e.g., 600) includes a charging mechanism configured to charge (e.g., charge via a wired connection and/or wirelessly charge) the external device (e.g., 604 and/or 644) while the external device is attached (e.g., magnetically attached, attached via a dock, and/or attached via a wire) to the device stand. In some embodiments, the attachment point includes the charging mechanism. In some embodiments, the charging mechanism includes one or more magnets that are configured to attach the external device to the device stand. In some embodiments, the device stand charges the external device while the external device is attached to the device stand. In some embodiments, the charging mechanism is configured to charge different types of external devices. Outputting a respective output at a device stand that includes a charging mechanism configured to charge an external device while the external device is attached to the device stand allows the device stand to illuminate an environment while charging the external device, thereby providing improved feedback.

In some embodiments, the one or more output devices includes one or more speakers. In some embodiments, outputting the respective output (e.g. illumination of 600a, 600b, 600c and/or 600d) that is generated based on the voice input (e.g., 605o) includes outputting, via the one or more speakers, an audio answer (e.g., 630) (e.g., an audible answer, one or more words, a tone, a media item, and/or an alarm) to the voice input. In some embodiments, one or more audio characteristics of the audio answer is based on one or more audio characteristics of the voice input. In some embodiments, the volume of the audio answer is based on a volume of the voice input. In some embodiments, the device stand outputs the audio answer while causing the external device to display information. Outputting an audio answer to a voice input allows a device stand to indicate that the voice input was detected and processed, thereby providing improved feedback and/or performing an operation when a set of conditions has been met without requiring further user input.

In some embodiments, the device stand (e.g., 600) includes a set of one or more light sources (e.g., lights that illuminate portions of device stand 600 corresponding to 600a, 600b, 600c, and/or 600d) (e.g., a single source such as a single light source or an array of light sources an array of light bulbs). In some embodiments, outputting the respective output (e.g. illumination of 600a, 600b, 600c and/or 600d) that is generated based on the voice input (e.g., 605o) includes illuminating, via the set of one or more light sources, a portion of the device stand based on the audio answer (e.g., 630) (e.g., based on content, volume, duration, speed, and/or tone of the audio answer). In some embodiments, the portion of the device stand is illuminated based on a speaker of the voice input (e.g., illuminated in different manners depending on which person provided the voice input). In some embodiments, in response to detecting the voice input, the device stand illuminates the portion of the device stand irrespective of the audio answer. Illuminating a portion of a device stand based on an audio answer allows the device stand to automatically perform an illumination operation that indicates at least one or more characteristics of the audio answer (e.g., content of the audio answer, volume of the audio answer, and/or tone of the audio answer), thereby providing improved visual feedback and/or performing an operation when a set of conditions has been met without requiring further user input.

In some embodiments, outputting the respective output (e.g. illumination of 600a, 600b, 600c and/or 600d) that is generated based on the voice input (e.g., 605o) includes, in accordance with a determination that the external device (e.g., 604 and/or 644) is attached (e.g., magnetically attached and/or mechanically attached, including temporarily attached and/or permanently attached) to the device stand (e.g., 600), outputting information (e.g., 632) via one or more display generation components of the external device. In some embodiments, outputting the respective output that is generated based on the voice input includes, in accordance with a determination that the external device is not attached to the device stand, forgoing output of the information based on the voice input via the one or more display generation components of the external device. In some embodiments, the one or more output devices includes one or more display generation components. In some embodiments, outputting the respective output that is generated based on the voice input includes, in accordance with a determination that the external device is not attached to the device stand, outputting, via the one or more display generation components, the information (e.g., with or without outputting the information via the one or more display generation components of the external device). In some embodiments, in response to detecting the voice input, the device stand causes the external device to launch an application. In some embodiments, the information is displayed, via the one or more display generation components of the external device, within a user interface of the application. In some embodiments, outputting the information via the one or more display generation components of the external device includes transmitting one or more instructions to the external device that cause the external device to display the information. Outputting information via one or more display generation components of an external device when a set of one or more prescribed conditions is met (e.g., the external device is attached to the device stand) allows the device stand to supplement an audio answer to the voice input with display of information, thereby performing an operation when a set of conditions has been met without requiring further user input.

In some embodiments, the information (e.g., 632) includes details (e.g., hyperlink, text, multimedia, webpage, and/or animation) that are not included in the audio answer (e.g., 630). In some embodiments, the information includes details that are included in the audio answer. In some embodiments, the details include a subset of the content that is included in the audio answer. In some embodiments, the content of the audio answer is a subset of the information. Outputting information via one or more display generation components of an external device when a set of one or more prescribed conditions is met (e.g., the external device is attached to the device stand) allows the device stand to supplement an audio answer to the voice input with the display of additional information, thereby performing an operation when a set of conditions has been met without requiring further user input.

In some embodiments, in response to detecting the voice input (e.g., 605o), the device stand performs an operation (e.g., adjusting a smart home device, adjusting display of the external device, moving a position of a portion of the device stand, controlling playback of media, and/or performing a telecommunications operation such as starting or ending a phone call or video communication session) based on the voice input (e.g., as described above in reference to FIG. 6P). In some embodiments, performing the operation is separate from outputting the respective output that is generated based on the voice input. In some embodiments, the operation is performed via the external device. In some embodiments, the device stand performs the operation while, before, during, or after outputting the respective output that is generated based on the voice input. In some embodiments, the device stand outputs the respective output while, before, during, or after performing the operation based on the voice input. In some embodiments, in response to detecting the voice input and/or in conjunction with (e.g., before, while, in response to, and/or after) performing the operation based on the voice input, the device stand outputs, via one or more output devices of the external device and/or the one or more output devices of the device stand, a status of performing the operation (e.g., while the operation is being performed). Performing an operation that is based on a voice input in response to detecting the voice input automatically allows a device stand to tailor performance of an operation based on one or more characteristics of the voice input, thereby providing additional control options without cluttering the user interface and/or performing an operation when a set of conditions has been met without requiring further user input.

In some embodiments, the voice input (e.g., 605o) is processed (e.g., transcribed and/or analyzed to determine one or more operations that correspond to the voice input and/or how to respond to the voice input) by a computer system that is external to the device stand (e.g., 600) (e.g., remotely processed by a separate device that is near the computer system or by a server that is accessed via a public or private data network). Processing a voice input on a computer system that is external to a device stand (e.g., and not on the device stand) frees up resources on the device stand while reducing a power consumption (e.g., and/or extending a battery life of) of the device stand, thereby extending the battery life of the device stand.

In some embodiments, the voice input (e.g., 605o) is processed (e.g., transcribed and/or analyzed to determine one or more operations that correspond to the voice input and/or how to respond to the voice input) by the device stand (e.g., 600) (and/or the external device). In some embodiments, a portion of processing (e.g., transcribing and/or analyzing to determine one or more operations that correspond to the voice input and/or how to respond to the voice input) of the voice input is performed by the device stand and another portion, different from the portion, of the processing of the voice input is performed by the computer system. In some embodiments, some voice inputs are remotely processed while other voice inputs are locally processed (e.g., depending on a complexity and/or one or more requirements of a respective voice input). Processing a voice input on a device stand that detects the voice input allows the voice input to be processed without the transmission of sensitive data that corresponds to the voice input and/or the speaker of the voice input, thereby increasing the security of the operation of the device stand.

Note that details of the processes described above with respect to process 700 (e.g., FIG. 7) are also applicable in an analogous manner to other processes described herein. For example, process 800 optionally includes one or more of the characteristics of the various processes described above with reference to process 700. For example, the illumination of process 800 can be performed in response to detecting the voice input of process 700. For brevity, these details are not repeated herein.

FIG. 8 is a flow diagram illustrating a process (e.g., process 800) for outputting illumination in accordance with some embodiments. Some operations in process 800 are, optionally, combined, the orders of some operations are, optionally, changed, and some operations are, optionally, omitted.

As described below, process 800 provides an intuitive way for outputting illumination. Process 800 reduces the cognitive burden on a user, thereby creating a more efficient human-machine interface. For battery-operated computing devices, enabling a user to interact with such devices faster and more efficiently conserves power and increases the time between battery charges.

In some embodiments, process 800 is performed at a device stand (e.g., 600) that includes one or more light sources (e.g., lights that illuminate portions of device stand 600 corresponding to 600a, 600b, 600c, and/or 600d) (e.g., LED lights, OLED lights, and/or halogen lights). In some embodiments, the device stand includes a hardware component that is configured to have an external device be coupled to the hardware component. In some embodiments, the device stand includes a hardware component that is configured to couple and/or be coupled with an external device. In some embodiments, the device stand includes a hardware component that is used to hold an external device. In some embodiments, the device stand includes a hardware component that is configured to support an external device. In some embodiments, the device stand includes and/or is in communication with one or more input devices (e.g., a physical input mechanism, a hardware input mechanism, a camera, a touch-sensitive surface, a microphone, a camera, a depth sensor, an accelerometer, a temperature sensor, and/or a heart monitor). In some embodiments, the physical input mechanism is a hardware input mechanism, a rotatable input mechanism, a crown, a knob, a dial, a physical slider, and/or a hardware button. In some embodiments, the device stand is in communication with a display generation component.

While an external device (e.g., 604 and/or 644) (e.g., a watch, a phone, a tablet, a fitness tracking device, a processor, a head-mounted display (HMD) device, a communal device, a media device, a speaker, a television, and/or a personal computing device) is coupled to (e.g., attached, to, integrated into, a part of, magnetically coupled to, wirelessly coupled, and/or wired) the device stand (e.g., 600), wherein the device stand includes an attachment point (e.g., 602) (e.g., a magnetic and/or mechanical attachment) that is configured to attach to the external device and hold the external device in a respective pose (e.g., a fixed pose or a dynamic pose, optionally a pose that would not be maintained by the external device if the external device were not attached to the attachment point) relative to a physical environment, the device stand detects (802) (e.g., via the one or more input devices) a respective event (e.g., event corresponding to 624a and/or 614) corresponding to (e.g., directed to, at a location of, related to and/or associated with) the external device (e.g., the external device generates a notification, the external device receives a text message or an e-mail, an alarm on the external device is triggered, the external device is de-coupled from the device stand, the external device is rotated, the external device transitions between operating states, and/or the external device receives a phone call). In some embodiments, the external device includes a display generation component and/or includes the one or more input devices. In some embodiments, when the external device is attached to the attachment point the device stand provides power to the external device and/or communicates with the external device (e.g., with a wired or wireless data connection). In some embodiments, the device stand receives the respective event corresponding to the external device.

In response to detecting the respective event (e.g., event corresponding to 624a and/or 614) corresponding to the external device (e.g., 604 and/or 644) (e.g., and/or while the external device is coupled to the device stand) and in accordance with a determination that the respective event is a first event (and/or a first type of event), the device stand illuminates (804), via the one or more light sources (e.g., lights that illuminate portions of device stand 600 corresponding to 600a, 600b, 600c, and/or 600d), a first portion of the device stand (e.g., 600) in a first manner (e.g. with a first level of brightness, with a first set of one or more colors, with a first frequency of pulsating light, for a first duration, and/or in a first direction). In some embodiments, the first portion of the device stand is located at a front side of the device stand (e.g., a side that the external device is coupled to the device stand), a side of the device stand (e.g., a side perpendicular to and/or at an angle from the front side), a rear side of the device stand (e.g., an opposite side of the device stand as compared to the front side), a top side of the device stand, and/or a bottom side of the device stand. In some embodiments, the device stand ceases illuminating the first portion of the device stand in response to detecting an input different from the respective event. In some embodiments, the device stand suspends performing an operation in response to detecting the respective event. In some embodiments, the device stand ceases to perform an operation in response to detecting the respective event. Illuminating a portion of a device stand in a particular manner in response to detecting an event corresponding to an external device allows the device stand to perform an illumination operation that indicates the type of event that occurs at the external device, thereby performing an operation when a set of conditions has been met without requiring further user input.

In some embodiments, in response to detecting the respective event (e.g., event corresponding to 624a and/or 614) corresponding to the external device (e.g., 604 and/or 644) (e.g., and/or while the external device is coupled to the device stand) and in accordance with a determination that the respective event is a second event (e.g., a second type of event different from the first type of event) different from the first event, the device stand illuminates, via the one or more light sources (e.g., lights that illuminate portions of device stand 600 corresponding to 600a, 600b, 600c, and/or 600d), a second portion (e.g., the first portion and/or another portion different from the first portion) of the device stand (e.g., 600) in a second manner (e.g., with a second level of brightness, with a second set of one or more colors, with a second frequency of pulsating light, in a second direction, for a second duration and/or in a second direction) different from the first manner. In some embodiments, illuminating the second portion of the device stand in the second manner is different from illuminating the first portion of the device stand in the first manner by a location of where the illumination occurs (e.g., and not different in how a respective portion is illuminated). In some embodiments, the first portion includes the second portion or vice versa. In some embodiments, the second portion of the device stand is located at the front side of the device stand, the side of the device stand, the rear side of the device stand, the top side of the device stand, and/or the bottom side of the device stand. Illuminating portions of a device stand in different manners in response to detecting different events corresponding to an external device allows the device stand to perform an illumination operation that indicates the type of event that occurs at the external device, thereby performing an operation when a set of conditions has been met without requiring further user input.

In some embodiments, the respective event (e.g., event corresponding to 624a and/or 614) includes (e.g., or is) an incoming (e.g., receiving and/or generating) notification (e.g., 624a and/or 614) (e.g., an audible, visual and/or haptic notification) at (and/or corresponding to, associated with, and/or from) the external device (e.g., 604 and/or 644). In some embodiments, the external device receives and/or generates the notification. In some embodiments, the respective event includes an incoming notification at the device stand. In some embodiments, the respective event is an incoming notification at the external device. Illuminating a portion of a device stand in response to detecting an incoming notification at an external device allows the device stand to provide an indication regarding the state of the external device, thereby providing improved visual feedback and/or performing an operation when a set of conditions has been met without requiring further user input.

In some embodiments, the respective event includes (e.g., or is) an update (e.g., a status update, a progress update, and/or information) to a live event (e.g., event corresponding to 634) (e.g., an ongoing and/or current activity, event, and/or task) corresponding to (e.g., being monitored by, registered with, and/or associated with) the external device (e.g., 604 and/or 644). In some embodiments, the respective event includes a notification of a future event or a previous event. In some embodiments, the external device generates the update. In some embodiments, a device other than the device stand and/or the external device generates the update. In some embodiments, the respective event corresponds to the device stand. Illuminating a portion of a device stand in response to detecting an update to a live event allows the device stand to perform an illumination operation that provide updates regarding the status of an ongoing event in real time, thereby providing improved visual feedback and/or performing an operation when a set of conditions has been met without requiring further user input.

In some embodiments, the respective event is a respective notification (e.g., 624a, 614, and/or 632) (e.g., external device receives the notification, the external device generates the notification, and/or the external device outputs the notification). In some embodiments, illuminating, via the one or more light sources (e.g., lights that illuminate portions of device stand 600 corresponding to 600a, 600b, 600c, and/or 600d), the first portion of the device stand (e.g., 600) in the first manner includes, in accordance with a determination that the respective notification is a first type of notification (e.g., 624a, 614, and/or 632) (e.g., a notification that corresponds to a first application, a notification that corresponds to a first type of event, a notification that corresponds to a first type of context, an audible notification, a visual notification, and/or a haptic notification), outputting, via the one or more light sources, a first color of light. In some embodiments, illuminating, via the one or more light sources (e.g., lights that illuminate portions of device stand 600 corresponding to 600a, 600b, 600c, and/or 600d), the first portion of the device stand (e.g., 600) in the first manner includes, in accordance with a determination that the respective notification is a second type of notification (e.g., 624a, 614, and/or 632) (e.g., a notification that corresponds to a second application, a notification that corresponds to a second type of event, a notification that corresponds to a second type of context, an audible notification, a visual notification, and/or a haptic notification) different from the first type of notification, outputting, via the one or more light sources, a second color of light different from the first color of light (e.g., without outputting the first color of light). In some embodiments, the device stand causes the external device to display a representation of the notification in response to detecting the respective event corresponding to the external device. In some embodiments, the device stand outputs the first and/or second color of light while the respective notification is detected. In some embodiments, the device stand outputs the first and/or second color of light after the respective notification is detected. In some embodiments, the device stand outputs the first and/or second color of light before, while, and/or after the external device outputs the respective notification. In some embodiments, the first color of light is a shade of the second color of light. In some embodiments, the second color of light includes the first color of light. Outputting a particular color of light when a set of prescribed conditions is met (e.g., the respective notification is a particular type of notification) allows a device stand to perform an illumination operation that indicates what type of notification is generated and/or received (e.g., by an external device that is coupled to the device stand and/or by the device stand), thereby performing an operation when a set of conditions has been met without requiring further user input and/or providing improved visual feedback.

In some embodiments, the first type of notification (e.g., 624a, 614, and/or 632) corresponds to (e.g., is generated by, concerns, directed to, related to, and/or associated with) a first application (e.g., a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application). In some embodiments, the second type of notification (e.g., 624a, 614, and/or 632) corresponds to (e.g., is generated by, concerns, directed to, related to, and/or associated with) a second application (e.g., a home application, a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application) that is different from the first application. In some embodiments, the first type of notification and the second type of notification correspond to the same application. In some embodiments, the first application and the second application are the same types of application or different types of applications. In some embodiments, the first application is an application that is installed on the external device, the device stand, and/or a device other than the external device and device stand. In some embodiments, the second application is an application that is installed on the external device, the device stand and/or a device other than the external device and device stand. Outputting a particular color of light when a set of prescribed conditions is met (e.g., the respective notification is from a particular application) allows a device stand to indicate which application generated the notification and/or which application the notification corresponds to, thereby performing an operation when a set of conditions has been met without requiring further user input and/or providing improved visual feedback.

In some embodiments, the first type of notification (e.g., 624a, 614, and/or 632) corresponds to (e.g., directed to, related to, is meant for, and/or associated with) a first recipient (e.g., a user registered with the external device and/or the device stand, a user that is not registered with the external device and/or the device stand, a user within a field-of-view of the device stand and/or the external device or a user not within the field-of-view of the device stand and/or the external device). In some embodiments, the second type of notification (e.g., 624a, 614, and/or 632) corresponds (e.g., directed to, related to, meant for, and/or associated with) to a second recipient (e.g., a user registered with the external device and/or the device stand, a user that is not registered with the external device and/or the device stand, a user within a field-of-view of the device stand and/or the external device or a user not within the field-of-view of the device stand and/or the external device) that is different from the first recipient. In some embodiments, the first type of notification is output while the first recipient is within a field-of-view of the device stand. In some embodiments, device stand cease to output the first type of notification when the first recipient transitions from being within the field-of-view of the device stand to outside of the field-of view of the device stand. Outputting a particular color of light when a set of prescribed conditions is met (e.g., the respective notification corresponds to a particular recipient) allows a device stand to indicate who the notification corresponds, thereby performing an operation when a set of conditions has been met without requiring further user input and/or providing improved visual feedback.

In some embodiments, the external device is a first external device (e.g. 604 and/or 644). In some embodiments, while the first external device is not coupled to the device stand (e.g., 600) (e.g., before the first external device is coupled to the device stand or after the first external device is de-coupled from the device stand) and while outputting the first color of light (e.g., as part of detecting the first type of notification corresponding to the first recipient), the device stand detects a coupling (e.g., a magnetic coupling, a wired coupling, and/or a mechanical coupling) of a second external device (e.g., 644 and/or 640) (e.g., a watch, a phone, a tablet, a fitness tracking device, a processor, a head-mounted display (HMD) device, a communal device, a media device, a speaker, a television, and/or a personal computing device) of the second recipient to the device stand. In some embodiments, in response to detecting the coupling of the second external device of the second recipient to the device stand, the device stand causes one or more display generation components of the second external device of the second recipient to display an indication (e.g., 642) (e.g., a representation of the notification and/or an animation) that the respective notification (e.g., 624a, 614, and/or 632) does not correspond to the second recipient (e.g., without displaying the content of the respective notification). In some embodiments, the device stand does not cause the one or more display generation components of the device of the second recipient to display the indication that the respective notification does not correspond to the second recipient. In some embodiments, the device stand changes which portion of the device stand is illuminated in response to detecting the coupling of the device of the second recipient. Causing one or more display generation components of an external device to display an indication that a respective notification does not correspond to a recipient in response to detecting a coupling of the external device to a device stand allows the device stand to maintain the confidential nature of the notification, thereby performing an operation when a set of conditions has been met without requiring further user input and/or providing improved visual feedback.

In some embodiments, the respective notification (e.g., 624a, 614, and/or 632) corresponds to (e.g., concerns, directed to, related to, and/or associated with) one or more messages (e.g., 638) (e.g., voice messages, electronic mail messages, text messages, and/or handwritten messages) that are accessible by the device stand (e.g., 600) (e.g., the messages are stored on the device stand and/or available to be accessed via a server and/or another device by the device stand). In some embodiments, the one or more messages are not accessible to the device stand once the one or more messages have been opened. In some embodiments, the one or more messages remain accessible to the device stand after the one or more messages have been opened. In some embodiments, the one or more messages are accessible to the device stand for a predetermined period of time. In some embodiments, the one or more messages are accessible to the device stand when a user has granted the device stand permission to access the one or more messages. In some embodiments, the one or more messages are not stored on the device stand.

In some embodiments, the respective event is a first respective event (e.g., 624a, 614, and/or 632). In some embodiments, the external device is a first external device (e.g., 604 and/or 644). In some embodiments, after detecting the first respective event (e.g., or while detecting the first respective event and/or while not illuminating the first portion of the device stand in the first manner), the device stand detects a second respective event (e.g., 624a, 614, and/or 632) corresponding to (e.g., concerns, directed to, related to, and/or associated with) a second external device (e.g., 604 and/or 644) (e.g., the second external device generates a notification, the second external device receives a text message or an e-mail, an alarm on the second external device is triggered, the second external device is de-coupled from the device stand, the second external device is rotated, the second external device transitions between operating states, and/or the external device receives a phone call) different from the first external device, wherein the second respective event is different from the first respective event. In some embodiments, the first respective event and the second respective event are the same or different types of events. In some embodiments, the first external device and the second external device are the same types of devices or different types of devices. In some embodiments, after detecting the second respective event and in an accordance with a determination that the first external device is within a predetermined distance (e.g., 1 inch-60 inches) of the device stand (e.g., 600) (e.g., and the second external device is not within the predetermined distance of the device stand), the device stand illuminates (e.g., and/or continuing to illuminate), via the one or more light sources (e.g., lights that illuminate portions of device stand 600 corresponding to 600a, 600b, 600c, and/or 600d), the first portion of the device stand in a first manner (e.g., with a first amount of brightness, with a first color, with a first size, and/or with a first flashing frequency). In some embodiments, after detecting the second respective event and in an accordance with a determination that the first external device is not within the predetermined distance of the device stand, the device stand forgoes illumination of, via the one or more light sources, the first portion of the device stand in the first manner. In some embodiments, after detecting the second respective event and in accordance with a determination that the second external device is within the predetermined distance of the device stand (e.g., and the first external device is not within the predetermined distance of the device stand), the device stand illuminates, via the one or more light sources, the first portion of the device stand in a second manner (e.g., with a second amount of brightness, with a second color, with a second size, and/or with a second flashing frequency) different from the first manner. In some embodiments, the device stands illuminates the first portion of the device in the first manner and the second manner in accordance with a determination that the first external device and the second external device are within the predetermined distance of the device stand. In some embodiments, the device stands illuminates the first portion of the device in a manner different from the first manner and/or the second manner in accordance with a determination that the first external device and the second external device are within the predetermined distance of the device stand. In some embodiments, the device stand does not illuminate the first portion of the device in accordance with a determination that neither the first external device nor the second external device are within the predetermined distance of the device stand. In some embodiments, after detecting the second respective event and in an accordance with a determination that the second external device is not within the predetermined distance of the device stand, the device stand forgoes illumination of, via the one or more light sources, the first portion of the device stand in the second manner. Illuminating a portion of a device stand in a particular manner when a set of prescribed conditions is met (e.g., an external device is within a predetermined distance of the device stand) allows the device stand to indicate which external devices are within a threshold distance of the device stand and whether said external devices have any pending notifications, thereby performing an operation when a set of conditions has been met without requiring further user input and/or providing improved visual feedback.

In some embodiments, the respective event is a respective notification (e.g., 624a, 614, and/or 632). In some embodiments, illuminating, via the one or more light sources (e.g., lights that illuminate portions of device stand 600 corresponding to 600a, 600b, 600c, and/or 600d), the first portion of the device stand (e.g., 600) in the first manner includes, in accordance with a determination that the respective notification corresponds to (e.g., concerns, directed to, related to, and/or associated with) a first type of notification (e.g., 624a, 614, and/or 632) (e.g., a notification is output in response to the occurrence of the respective event, a notification is output a part of the occurrence of the respective event, a notification that is by the external computer system, a notification that is received by the external computer system, and/or a notification that is generated by the external computer system), outputting a first pattern (e.g., a flashing pattern, a color pattern, a striped pattern, and/or a repeating pattern). In some embodiments, illuminating, via the one or more light sources (e.g., lights that illuminate portions of device stand 600 corresponding to 600a, 600b, 600c, and/or 600d), the first portion of the device stand (e.g., 600) in the first manner includes, in accordance with a determination that the respective notification corresponds to (e.g., concerns, directed to, related to, and/or associated with) a second type of notification (e.g., 624a, 614, and/or 632) (e.g., a notification is output in response to the occurrence of the respective event, a notification is output a part of the occurrence of the respective event, a notification that is output by the external computer system, a notification that is received by the external computer system, and/or a notification that is generated by the external computer system) different from the first type notification, outputting (e.g., has, is, and/or is comprised of) a second pattern (e.g., a flashing pattern, a color pattern, a striped pattern, and/or a repeating pattern) different from the first pattern. In some embodiments, the type of pattern that is output is based on the respective event. Outputting a particular pattern when a set of prescribed conditions is met (e.g., the notification is a first type of notification or a second type of notification) allows the device stand to visually indicate what type of notification is detected and/or what type of notification is currently pending, thereby performing an operation when a set of conditions has been met without requiring further user input and/or providing improved visual feedback.

In some embodiments, the first type of notification (e.g., 624a, 614, and/or 632) corresponds to (directed to, related to, and/or associated with) a first amount of urgency (e.g., importance, priority, and/or seriousness). In some embodiments, the second type of notification (e.g., 624a, 614, and/or 632) corresponds to (e.g., directed to, related to, and/or associated with) a second amount of urgency that is less than the first amount of urgency. In some embodiments, the amount of urgency that corresponds to the first type of notification and/or the second type of notification is determined by the device stand and/or the external device.

In some embodiments, the device stand (e.g., 600) illuminates the first portion of the device stand in response to detecting the respective event (e.g., 624a, 614, and/or 632) while (e.g., in conjunction with and/or during which) the external device (e.g., 604 and/or 644) displays a user interface that corresponds to the respective event (e.g., the user interface includes content such as text, images, and/or videos that correspond to the respective event). In some embodiments, the first portion of the device stand is illuminated while the external device does not display the user interface corresponding to the respective event. In some embodiments, in response to detecting the respective event corresponding to the external device, the device stand transmits instructions to the external device that cause the external device to display the user interface that corresponds to the respective event. In some embodiments, the device stand initiates the illumination of the first portion of the device stand before or after the external device initiates display of the user interface. In some embodiments, the external device displays the user interface in response to detecting an occurrence of the respective event. Illuminating a portion of a device stand in response to detecting a respective event while an external device displays a user interface that corresponds to the respective event allows the device stand to perform an illumination operation that supplements the information that is displayed by the external display, thereby providing improved visual feedback and/or performing an operation when a set of conditions has been met without requiring further user input.

In some embodiments, the respective event corresponds to (e.g., concerns, directed to, related to, is, and/or associated with) an output of a notification (e.g., 614) in response to a first period of time expiring (e.g., an alarm expiring and/or a timer expiring). In some embodiments, the period of time is selected by a user. In some embodiments, the period of time is selected by the device stand and/or the external device. Illuminating a portion of a device stand in a particular manner in response to detecting output of a notification in response to a period of time expiring allows the device stand to capture the attention of a user such that the user is alerted to the expiration of the first period of time, thereby providing improved visual feedback and/or performing an operation when a set of conditions has been met without requiring further user input.

In some embodiments, while illuminating the first portion of the device stand (e.g., 600) (e.g., while the respective event is ongoing, while continuing to detect the respective event, or while the respective event is no longer on going), the device stand detects an expiration of a second period of time (e.g., an alarm expiring and/or a timer expiring). In some embodiments, the second period of time is chosen by a user of the device stand and/or the external device. In some embodiments, the second period of time is a default period of time. In some embodiments, the second period of time is different from or the same as the first period of time. In some embodiments, the second period of time is before the first period of time. In some embodiments, in response to detecting the expiration of the second period of time (e.g., and while continuing to detect the respective event, while continuing to illuminate the first portion of the device stand, while no longer detecting the respective event, or while no longer illuminating the first portion of the device stand), the device stand changes (e.g., gradually changing), via the one or more light sources (e.g., lights that illuminate portions of device stand 600 corresponding to 600a, 600b, 600c, and/or 600d), the illumination of the first portion of the device stand (e.g., changing the size, color, brightness, and/or other visual characteristic of the illumination of the first portion of the device stand). In some embodiments, the device stand reverts the changes to the illumination of the first portion of the device stand in response to detecting a subsequent expiration of the second period of time. In some embodiments, the device stand maintains the changes to the illumination of the first portion of the device stand in response to detecting the subsequent expiration of the second period of time. In some embodiments, the changes to the illumination of the first portion of the device stand is additive to the illumination of the first portion of the device stand. In some embodiments, the device stand does not change the illumination of the first portion of the device stand in response to detecting the expiration of the second period of time. In some embodiments, in response to detecting the expiration of the second period of time, the device stand changes the illumination of a portion of the device stand different from the first portion of the device stand. Changing an illumination of a portion of a device stand in response to detecting an expiration of a period of time allows the device stand to indicate that a predetermined amount of time has elapsed since the notification was initially output, thereby providing improved visual feedback and/or performing an operation when a set of conditions has been met without requiring further user input.

In some embodiments, the change to the illumination of the first portion of the device stand (e.g., 600) includes a change to one or more colors of the illumination of the first portion of the device stand (e.g., as described above in reference to FIG. 6F). In some embodiments, the change in the one or more colors of the illumination of the first portion of the device stand is based on the type of respective event that is detected. In some embodiments, the change in the one or more colors of the illumination of the first portion of the device stand is based on a context of, one or more objects present in, and/or one or more activities being performed in the environment of the device stand. In some embodiments, the change in the one or more colors of the illumination of the first portion of the device stand is based on a current time.

In some embodiments, the change to the illumination of the first portion of the device stand (e.g., 600) includes a change to a brightness of the illumination of the first portion of the device stand (e.g., as described above in reference to FIG. 6G). In some embodiments, the change in the brightness of the illumination of the first portion of the device stand is based on the type of respective event that is detected. In some embodiments, the change in the brightness of the illumination of the first portion of the device stand is based on a context of, one or more objects present in, and/or one or more activities being performed in the environment of the device stand. In some embodiments, the change in the brightness of the illumination of the first portion of the device stand is based on a current time.

In some embodiments, while (e.g., audibly outputs and/or displays) the notification (e.g., 624a, 614, and/or 632) is output, the device stand detects, via one or more input devices of the device stand or the external device (e.g., 604 and/or 644), a set of one or more inputs (e.g., 605f and/or 605i) (e.g., a voice input, a touch input, a button press input, and/or an air gesture) directed to the notification (e.g., the output of the notification is ceased or suspended, the volume of the output of the notification is adjusted and/or the brightness of the output of the notification is changed). In some embodiments, in response to detecting the set of one or more inputs directed to the notification, the device stand changes a state of the notification and changes, via the one or more light sources (e.g., lights that illuminate portions of device stand 600 corresponding to 600a, 600b, 600c, and/or 600d), the illumination of the first portion of the device stand (e.g., 600) (e.g., change a brightness, a color, a pattern, a tone, cease to output the illumination and/or suspend the output of the illumination of the first portion of the device stand). In some embodiments, the device stand does not change the illumination of the first portion of the device stand in in conjunction with the change to the state of the notification (e.g., in response to the user input directed to the notification). In some embodiments, the notification is no longer output when the state of the output of the notification changes. Changing an illumination of a portion of a device stand in response to detecting a change to a state of a notification allows the device stand to perform an illumination operation that indicates how and/or why the state of the notification is changed, thereby providing improved visual feedback and/or performing an operation when a set of conditions has been met without requiring further user input.

In some embodiments, while the notification (e.g., 624a, 614, and/or 632) is output, the device stand detects, via one or more input devices of the device stand (e.g., 600) or the external device (e.g., 604 and/or 644), a set of one or more inputs (e.g., 605f and/or 605i) that corresponds to (e.g., concerns, directed to, related to, and/or associated with) a respective request (e.g., a tap input, button press, air gesture, and/or a voice command) to alter the output of the notification (e.g., alter the volume, the brightness, the size, the frequency, and/or the intensity of the notification). In some embodiments, the respective request is a tap input that corresponds to selection of a user interface object that is displayed by the external display. In some embodiments, in response to detecting the set of one or more inputs that corresponds to the respective request to alter the output of the notification and in accordance with a determination that the respective request is a first type of request (e.g., the respective request includes a request for the notification to no longer be output such as stopping the output of notification, the respective request includes a request for a first operation to be performed, the respective request corresponds to selection of a first user interface object, and/or the respective request is performed by a particular user), the device stand changes, via the one or more light sources (e.g., lights that illuminate portions of device stand 600 corresponding to 600a, 600b, 600c, and/or 600d), the illumination of the first portion of the device stand (e.g., 600) in a first manner (e.g., change a brightness, a color, a pattern, a tone, cease to output the illumination and/or suspend the output of the illumination of the first portion of the device stand). In some embodiments, in response to detecting the set of one or more inputs that corresponds to the respective request to alter the output of the notification and in accordance with a determination that the respective request is a second type of request (e.g., the respective request includes a request for the notification to be output when another period of time, different from the first period of time, expires such as a snooze operation, the respective request includes a request for a second operation to be performed, the respective request corresponds to selection of a second user interface object, and/or the respective request is performed by a particular user) different from the first type of request, the device stand changes, via the one or more light sources, the illumination of the first portion of the device stand in a second manner different from the first manner (e.g., change a brightness, a color, a pattern, a tone, cease to output the illumination and/or suspend the output of the illumination of the first portion of the device stand). In some embodiments, the device stand changes the notification or the output of the notification in a third manner in response to the device stand detecting the set of one or more inputs that corresponds to the respective request to alter the output of the notification and in accordance with a determination that the respective request is the first type of request. In some embodiments, the device stand changes the notification or the output of the notification in a fourth manner different from the third manner in response to the device stand detecting the set of one or more inputs that corresponds to the respective request to alter the output of the notification and in accordance with a determination that the respective request is the second type of request. Changing an illumination of a portion of a device stand when a set of prescribed conditions is met (e.g., when the respective request is a first type of request or a second type of request) allows the device stand to perform an illumination operation that indicates how a state of a notification has changed, thereby performing an operation when a set of conditions has been met without requiring further user input.

In some embodiments, the first type of request includes (e.g., or is) a request for the external device (e.g., 604 and/or 644) to cease the output of the notification (e.g., 624a, 614, and/or 632) (e.g., cease displaying the notification, cease outputting an audible tone that corresponds to the notification, and/or cease outputting haptic outputs corresponding to the notification). In some embodiments, changing the illumination of the first portion of the device stand (e.g., 600) in the first manner includes ceasing the illumination of, via the one or more light sources (e.g., lights that illuminate portions of device stand 600 corresponding to 600a, 600b, 600c, and/or 600d), the first portion (e.g., and/or any portion) of the device stand. In some embodiments, the device stand ceases the illumination of the first portion of the device stand until another event that is the same type of event as the respective event is sequentially detected. In some embodiments, the device stand ceases the illumination of the first portion of the device until another event different from the respective event is detected. Ceasing illumination of a portion of a device stand when a set of prescribed conditions is met (e.g., in response to detecting a first type of request) allows the device stand to indicate what type of action an external device performs with respect to a notification, thereby providing improved visual feedback and/or thereby performing an operation when a set of conditions has been met without requiring further user input.

In some embodiments, the second type of request includes (e.g., or is) a request for the external device (e.g., 604 and/or 644) to suspend the output of the notification (e.g., 624a, 614, and/or 632) (e.g., suspend displaying the notification, suspend outputting an audible tone that corresponds to the notification, suspend outputting haptic outputs corresponding to the notification). In some embodiments, changing the illumination of the first portion of the device stand (e.g., 600) in the second manner includes (e.g., for 5-600 seconds) reducing a brightness (e.g., dimming, fading, and/or darkening) of the illumination of the first portion of the device stand. In some embodiments, the brightness of the illumination of the first portion of the device stand is temporarily decreased. In some embodiments, the device stand reduces the brightness of the illumination of the first portion of the device stand until a third notification that corresponds to the respective event is output (e.g., by the device stand and/or by the external device). In some embodiments, the request for the external device to suspend the output of the notification is a request to suspend the output of the notification for a predetermined period of time. Reducing a brightness of an illumination of a portion of a device stand when a set of prescribed conditions is met (e.g., in response to detecting a second type of request) allows the device stand to indicate what type of action an external device performs with respect to a notification, thereby providing improved visual feedback and/or thereby performing an operation when a set of conditions has been met without requiring further user input.

In some embodiments, the respective event corresponds to a message (e.g., 638) (e.g., a text message, an e-mail, and/or a handwritten message) transmitted (e.g., wirelessly transmitted and/or transmitted via a wire) to the device stand (e.g., 600) by an external device (e.g., 604 and/or 644) that was previously coupled to the device stand (e.g., different from the external device that is coupled to the device stand). In some embodiments, the respective event corresponds to a message transmitted to the device stand by the external device that is coupled to the device stand. In some embodiments, the message is generated by the external device that was previously coupled to the device stand. In some embodiments, the message is generated by a particular external device that was not coupled to the device stand. In some embodiments, the message is transmitted to the device stand while the external device that was previously coupled to the device stand was coupled to the device stand. Illuminating a portion of a device stand in response detecting a message that is transmitted to the device stand by an external device that was previously coupled to the device stand allows the device stand to provide an indication regarding a number of messages that have been transmitted to the device stand and for whom those messages are intended for, thereby providing improved visual feedback and/or performing an operation when a set of conditions has been met without requiring further user input.

In some embodiments, the external device (e.g., 604 and/or 644) that is coupled to the device stand (e.g., 600) is a first external device (e.g., 644 and/or 640). In some embodiments, while the first external device is not coupled to the device stand (e.g., before the first external device is coupled to the device stand and/or after the first external device is decoupled from the device stand), the device stand detects (e.g., after detecting that respective event that corresponds to the message being transmitted to the device stand by the first external device and/or while illuminating the first portion of the device stand) a coupling (e.g., a magnetic coupling and/or a mechanical coupling) of a second external device (e.g., 644 and/or 640) (e.g., a smart phone and/or a tablet), different from the first external device, to the device stand. In some embodiments, the first external device and the second external device are the same types of devices. In some embodiments, the first external device and the second external device are registered with different users. In some embodiments, the first external device and the second external device are registered with the same user. In some embodiments, in response to detecting the coupling of the second external device to the device stand and in accordance with a determination that the message (e.g., 638) corresponds to the second external device, the device stand causes the second external device to display a representation (e.g., 646) of the message. In some embodiments, in response to detecting the coupling of the second external device to the device stand and in accordance with a determination that the message does not correspond to the second external device, the device stand does not cause the second external device to display the representation of the message. In some embodiments, in response to detecting the coupling of the second external device to the device stand and in accordance with a determination that the message corresponds to the second external device, the device stand causes the second external device to display the content of the message. Causing an external device to display a representation of a message in response to detecting a coupling of the external device to a device stand and when a set of prescribed conditions is met (e.g., the message corresponds to the external device) allows the device stand to prevent an individual other than the intended recipient of the message to know of the message, thereby performing an operation when a set of conditions has been met without requiring further user input.

In some embodiments, before detecting the coupling of the second external device (e.g., 604 and/or 644) to the device stand (e.g., 600), the device stand detects a respective number of events (e.g., an external computer system generates a notification, an external computer system outputs an alarm, an external computer system receives a notification, a message is stored on the device stand, the device stand detects an individual and/or an update to a live event). In some embodiments, in response to detecting the respective number of events and in accordance with a determination that the respective number of events is a first number of events, the device stand illuminates, via the one or more light sources (e.g., lights that illuminate portions of device stand 600 corresponding to 600a, 600b, 600c, and/or 600d), the device stand in a first manner (e.g., and/or a first number of lights of the device stand). In some embodiments, illuminating the device stand in the first manner is representative of the first number of events. In some embodiments, in response to detecting the respective number of events and in accordance with a determination that the respective number of events is a second number of events different from the first number of events, the device stand illuminates, via the one or more light sources, the device stand in a second manner (e.g., and/or a second number of lights of the device stand different from the first number of lights) different from the first manner. In some embodiments, illuminating the device stand in the first manner includes illuminating one or more light sources of the device stand positioned at a first position and illuminating the device stand in the second manner corresponds to illuminating one or more light sources positioned at a second position of the device stand different from the first position. In some embodiments, illuminating the device stand in the second manner is representative of the second number of events. Illuminating a device stand in a particular manner based on a number of events that are detected prior to a coupling of an external device automatically allows the device stand to perform an illumination operation that indicates a number of pending and/or stored notifications and/or messages, thereby performing an operation when a set of conditions has been met without requiring further user input.

In some embodiments, the device stand (e.g., before, during, or while illuminating the first portion of the device stand in response to detecting the respective event) detects a weather event (e.g., a current weather event, a previous weather event, or a future weather event such as a rain storm, snow, windy weather, thunderstorm, cloudy weather, and/or sunny weather). In some embodiments, detecting the weather event includes the device stand receiving data regarding the weather event from the external device or another device different from the external device. In some embodiments, a sensor of the device stand such as a camera and/or microphone detects the weather event. In some embodiments, in response to detecting the weather event, the device stand outputs, via the one or more light sources (e.g., lights that illuminate portions of device stand 600 corresponding to 600a, 600b, 600c, and/or 600d), an indication (e.g., clouds, raindrops, the sun, the moon, and/or snowflakes) of the weather event (e.g., as discussed above in reference to FIG. 6K). In some embodiments, the device stand outputs the indication of the weather on a surface external to the device stand (e.g., a wall behind, in front, underneath, or to the side of the device stand). In some embodiments, the device stand changes the indication of the weather event in real time as the weather event changes. In some embodiments, the device stand ceases to output the indication of the weather event in accordance with a determination that the indication of the weather event becomes obstructed (e.g., an object or an individual obfuscates the indication). In some embodiments, the device stand outputs different colors of light based on the type of detected weather event for example the device stand outputs a yellow color when the detected weather event is a sunny condition and the device stand outputs a red color when the detected weather event is a thunderstorm. Outputting an indication of a weather event in response to detecting a weather event allows the device stand to provide an indication of a previous weather condition, a current weather condition, and/or a future weather condition at a location of the device stand and/or at a location that is remote to the device stand, thereby performing an operation when a set of conditions has been met without requiring further user input interface and/or providing improved visual feedback.

In some embodiments, the device stand (e.g., before, during, or while illuminating the first portion of the device stand in response to detecting the respective event) detects an individual (e.g., an individual that is registered with the device stand and/or the external device or an individual that is not registered with the device stand and/or the external device). In some embodiments, a sensor of the device stand such as a camera, proximity sensor and/or microphone detects the individual. In some embodiments, in response to detecting the individual, the device stand outputs, via the one or more light sources (e.g., lights that illuminate portions of device stand 600 corresponding to 600a, 600b, 600c, and/or 600d), an indication of the individual (e.g., as discussed above in reference to FIG. 6D) (e.g., a silhouette of the individual, a color of light that corresponds to the individual, a pattern of light that corresponds to the individual). In some embodiments, the device stand outputs the indication of the individual on a portion of the device stand. In some embodiments, the device stand outputs the indication of the individual on a surface that is external to the device stand (e.g., a surface that is below, above, to the side and/or underneath the device stand). In some embodiments, the respective event is the detection of an individual that is registered with the external device. In some embodiments, the device stand ceases to output the indication of the individual in accordance with a determination that the indication of the individual becomes obstructed (e.g., an object or an individual obfuscates the indication). In some embodiments, the indication of the individual is based on which individual is detected and/or which notification is received (e.g., by the device stand and/or by the external device). For example, the device stand outputs a yellow light when a first individual is detected and the device stand outputs a green light when a second individual different from the first individual is detected. For another example, the device stand outputs a red light when a first notification is received and an orange light when a second notification different from the first notification is detected. Outputting an indication of an individual in response to detecting the individual allows a device stand to indicate whether an individual is detected to be within an environment of the device stand, thereby providing improved visual feedback and/or performing an operation when a set of conditions has been met without requiring further user input.

In some embodiments, the device stand (e.g., before, during, or while illuminating the first portion of the device stand in response to detecting the respective event) detects an individual (e.g., an individual that is registered with the device stand and/or the external device or an individual that is not registered with the device stand and/or the external device) (e.g. as discussed above in reference to FIG. 6D). In some embodiments, a sensor of the device stand such as a camera, proximity sensor and/or microphone detects the individual In some embodiments, in response to detecting the individual and in accordance with a determination that the individual is detected during a first time of day (e.g., the morning, the afternoon, or the evening), the device stand forgoes output of, via the one or more light sources (e.g., lights that illuminate portions of device stand 600 corresponding to 600a, 600b, 600c, and/or 600d), an indication (e.g., illumination of 600a, 600b, 600c, and/or 600d) of the individual (e.g., and/or any indication of the individual). In some embodiments, in response to detecting the individual and in accordance with a determination that the individual is detected during a second time of day (e.g., the morning, the afternoon, or the evening) different from the first time of day, the device stand outputs, via the one or more light sources, the indication of the individual. In some embodiments, the first time corresponds to a time of day where there is limited and/or no ambient light (e.g., the late night and/or early morning) and the second time corresponds to a time of day where there is ambient lighting (e.g., morning and/or afternoon). In some embodiments, the device stand output the indication of the individual irrespective of what time the individual is detected.

In some embodiments, the respective event (e.g., 624a, 614, and/or 632) corresponds to content (e.g., 620 and/or) 622 (e.g., still photos and/or videos being played back by the external device) displayed by the external device (e.g., 604 and/or 644). In some embodiments, illuminating the first portion of the device stand (e.g., 600) includes, in accordance with a determination that the content displayed by the external display includes a first set of one or more colors, illuminating the first portion of the device stand with a second set of one or more colors (e.g., the second set of one or more colors is based on the first set of one or more colors). In some embodiments, the first set of one or more colors is the same as the second set of one or more colors. In some embodiments, illuminating the first portion of the device stand (e.g., 600) includes, in accordance with a determination that the content displayed by the external display includes a third set of one or more colors different from the first set of colors, illuminating the first portion of the device stand with a fourth set of one or more colors (e.g., the fourth set of one or more colors is based on the third set of one or more colors) different from the second set of colors (e.g., as discussed above in reference to FIG. 6L). In some embodiments, the device stand changes the illumination of the first portion of the device stand based on changes to the content being displayed by the external display. In some embodiments, the fourth set of one or more colors is the same as the third set of one or more colors. Illuminating a portion of a device stand with a set of one or more colors when a set of one or more prescribed conditions is met (e.g., the external device displays a certain type of content) allows the device stand to complement display of the external device in a manner that provides an indication of what is displayed by the external device, thereby providing improved visual feedback and/or performing an operation when a set of conditions has been met without requiring further user input.

Note that details of the processes described above with respect to process 800 (e.g., FIG. 8) are also applicable in an analogous manner to the processes described herein. For example, process 700 optionally includes one or more of the characteristics of the various processes described herein with reference to process 800. For example, the device stand of process 800 can be the device stand of process 700. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

In some embodiments, content is automatically generated by one or more computer systems in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other embodiments, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some embodiments, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve providing outputs. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for providing outputs. Accordingly, use of such personal information data enables users to have a device stand perform operations for providing outputs. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an application that their personal information data will be accessed and then reminded again just before personal information data is accessed by the application.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to some services, or publicly available information.

What is claimed is:

1. A method, comprising:
at a device stand that includes one or more light sources:
while an external device is coupled to the device stand, wherein the device stand includes an attachment point that is configured to attach to the external device and hold the external device in a respective pose relative to a physical environment, detecting a respective event corresponding to the external device; and
in response to detecting the respective event corresponding to the external device and in accordance with a determination that the respective event is a first event, illuminating, via the one or more light sources, a first portion of the device stand in a first manner.

2. The method of claim 1, further comprising:
in response to detecting the respective event corresponding to the external device and in accordance with a determination that the respective event is a second event different from the first event, illuminating, via the one or more light sources, a second portion of the device stand in a second manner different from the first manner.

3. The method of claim 1, wherein the respective event includes an incoming notification at the external device.

4. The method of claim 1, wherein the respective event includes an update to a live event corresponding to the external device.

5. The method of claim 1, wherein:
the respective event is a respective notification; and
illuminating, via the one or more light sources, the first portion of the device stand in the first manner includes:
in accordance with a determination that the respective notification is a first type of notification, outputting, via the one or more light sources, a first color of light; and
in accordance with a determination that the respective notification is a second type of notification different from the first type of notification, outputting, via the one or more light sources, a second color of light different from the first color of light.

6. The method of claim 5, wherein:
the first type of notification corresponds to a first application; and
the second type of notification corresponds to a second application that is different from the first application.

7. The method of any claim 5, wherein:
the first type of notification corresponds to a first recipient; and
the second type of notification corresponds to a second recipient that is different from the first recipient.

8. The method of claim 7, wherein the external device is a first external device, the method further comprising:
while the first external device is not coupled to the device stand and while outputting the first color of light, detecting a coupling of a second external device of the second recipient to the device stand; and
in response to detecting the coupling of the second external device of the second recipient to the device stand, causing one or more display generation components of the second external device of the second recipient to display an indication that the respective notification does not correspond to the second recipient.

9. The method of claim 5, wherein the respective notification corresponds to one or more messages that are accessible by the device stand.

10. The method of claim 1, wherein the respective event is a first respective event, wherein the external device is a first external device, the method further comprising:
after detecting the first respective event, detecting a second respective event corresponding to a second external device different from the first external device, wherein the second respective event is different from the first respective event; and
after detecting the second respective event:
in an accordance with a determination that the first external device is within a predetermined distance of the device stand, illuminating, via the one or more light sources, the first portion of the device stand in a first manner; and
in accordance with a determination that the second external device is within the predetermined distance of the device stand, illuminating, via the one or more light sources, the first portion of the device stand in a second manner different from the first manner.

11. The method of claim 1, wherein:
the respective event is a respective notification; and
illuminating, via the one or more light sources, the first portion of the device stand in the first manner includes:
in accordance with a determination that the respective notification corresponds to a first type of notification, outputting a first pattern; and
in accordance with a determination that the respective notification corresponds to a second type of notification different from the first type notification, outputting a second pattern different from the first pattern.

12. The method of claim 11, wherein the first type of notification corresponds to a first amount of urgency, and wherein the second type of notification corresponds to a second amount of urgency that is less than the first amount of urgency.

13. The method of claim 1, wherein the device stand illuminates the first portion of the device stand in response to detecting the respective event while the external device displays a user interface that corresponds to the respective event.

14. The method of claim 1, wherein the respective event corresponds to an output of a notification in response to a first period of time expiring.

15. The method of claim 14, further comprising:
while illuminating the first portion of the device stand, detecting an expiration of a second period of time; and
in response to detecting the expiration of the second period of time, changing, via the one or more light sources, the illumination of the first portion of the device stand.

16. The method of claim 15, wherein the change to the illumination of the first portion of the device stand includes a change to one or more colors of the illumination of the first portion of the device stand.

17. The method of claim 15, wherein the change to the illumination of the first portion of the device stand includes a change to a brightness of the illumination of the first portion of the device stand.

18. The method of claim 14, further comprising:
while the notification is output, detecting, via one or more input devices of the device stand or the external device, a set of one or more inputs directed to the notification; and
in response to detecting the set of one or more inputs directed to the notification, changing a state of the notification and changing, via the one or more light sources, the illumination of the first portion of the device stand.

19. The method of claim 14, further comprising:
while the notification is output, detecting, via one or more input devices of the device stand or the external device, a set of one or more inputs that corresponds to a respective request to alter the output of the notification; and
in response to detecting the set of one or more inputs that corresponds to the respective request to alter the output of the notification:
in accordance with a determination that the respective request is a first type of request, changing, via the one or more light sources, the illumination of the first portion of the device stand in a first manner; and
in accordance with a determination that the respective request is a second type of request different from the first type of request, changing, via the one or more light sources, the illumination of the first portion of the device stand in a second manner different from the first manner.

20. The method of claim 19, wherein:
the first type of request includes a request for the external device to cease the output of the notification; and
changing the illumination of the first portion of the device stand in the first manner includes ceasing the illumination of, via the one or more light sources, the first portion of the device stand.

21. The method of claim 19, wherein:
the second type of request includes a request for the external device to suspend the output of the notification; and
changing the illumination of the first portion of the device stand in the second manner includes reducing a brightness of the illumination of the first portion of the device stand.

22. The method of claim 1, wherein the respective event corresponds to a message transmitted to the device stand by an external device that was previously coupled to the device stand.

23. The method of claim 22, wherein the external device that is coupled to the device stand is a first external device, the method further comprising:
while the first external device is not coupled to the device stand, detecting a coupling of a second external device, different from the first external device, to the device stand; and
in response to detecting the coupling of the second external device to the device stand and in accordance with a determination that the message corresponds to the second external device, causing the second external device to display a representation of the message.

24. The method of claim 23, further comprising:
before detecting the coupling of the second external device to the device stand, detecting a respective number of events; and
in response to detecting the respective number of events:
in accordance with a determination that the respective number of events is a first number of events, illuminating, via the one or more light sources, the device stand in a first manner; and
in accordance with a determination that the respective number of events is a second number of events different from the first number of events, illuminating, via the one or more light sources, the device stand in a second manner different from the first manner.

25. The method of claim 1, further comprising:
detecting a weather event; and
in response to detecting the weather event, outputting, via the one or more light sources, an indication of the weather event.

26. The method of claim 1, further comprising:
detecting an individual; and
in response to detecting the individual, outputting, via the one or more light sources, an indication of the individual.

27. The method of claim 1, further comprising:
detecting an individual; and
in response to detecting the individual:
in accordance with a determination that the individual is detected during a first time of day, forgoing output of, via the one or more light sources, an indication of the individual; and
in accordance with a determination that the individual is detected during a second time of day different from the first time of day, outputting, via the one or more light sources, the indication of the individual.

28. The method of claim 1, wherein:
the respective event corresponds to content displayed by the external device; and
illuminating the first portion of the device stand includes:
in accordance with a determination that the content displayed by the external display includes a first set of one or more colors, illuminating the first portion of the device stand with a second set of one or more colors; and
in accordance with a determination that the content displayed by the external display includes a third set of one or more colors different from the first set of colors, illuminating the first portion of the device stand with a fourth set of one or more colors different from the second set of colors.

29. A non-transitory computer-readable storage medium storing one or more programs configured to be executed by one or more processors of a device stand that includes one or more light sources, the one or more programs including instructions for:
while an external device is coupled to the device stand, wherein the device stand includes an attachment point that is configured to attach to the external device and hold the external device in a respective pose relative to a physical environment, detecting a respective event corresponding to the external device; and
in response to detecting the respective event corresponding to the external device and in accordance with a determination that the respective event is a first event, illuminating, via the one or more light sources, a first portion of the device stand in a first manner.

30. A device stand that includes one or more light sources, comprising:
one or more processors; and
memory storing one or more programs configured to be executed by the one or more processors, the one or more programs including instructions for:
while an external device is coupled to the device stand, wherein the device stand includes an attachment point that is configured to attach to the external device and hold the external device in a respective pose relative to a physical environment, detecting a respective event corresponding to the external device; and
in response to detecting the respective event corresponding to the external device and in accordance with a determination that the respective event is a first event, illuminating, via the one or more light sources, a first portion of the device stand in a first manner.
